(19) United States
(12) Patent Application Publication
(10) Pub. No.: US 2020/0253413 A1
(43) Pub. Date: Aug. 13, 2020

(54) METHOD AND APPARATUS FOR LANDFILL REDUCTION

(71) Applicant: Anthony J. Orler, Valencia, CA (US)

(72) Inventor: Anthony J. Orler, Valencia, CA (US)

(21) Appl. No.: 16/784,031

(22) Filed: Feb. 6, 2020

Related U.S. Application Data
(63) Continuation-in-part of application No. 16/274,088, filed on Feb. 12, 2019.
Application No. 16/274,088 is a continuation-in-part of application No. 16/012,166, filed on Jun. 19, 2018.
Application No. 16/012,166 is a continuation-in-part of application No. 16/012,157, filed on Jun. 19, 2018.
Application No. 16/012,157 is a continuation-in-part of application No. 16/012,144, filed on Jun. 19, 2018.
Application No. 16/012,144 is a continuation-in-part of application No. 16/012,129, filed on Jun. 19, 2018.
Application No. 16/012,129 is a continuation-in-part of application No. 16/012,114, filed on Jun. 19, 2018.
Application No. 16/012,114 is a continuation-in-part of application No. 16/012,096, filed on Jun. 19, 2018.
Application No. 16/012,096 is a continuation-in-part of application No. 15/676,977, filed on Aug. 14, 2017.
(60) Provisional application No. 62/832,114, filed on Apr. 10, 2019.
(60) Provisional application No. 62/403,170, filed on Oct. 2, 2016.
(60) Provisional application No. 62/374,862, filed on Aug. 14, 2016.

(51) Int. Cl. A47J 31/40; B65D 85/804

(52) U.S. Cl. CPC A47J 31/407; B65B 29/022; B65D 85/8043

(57) ABSTRACT

Systems, methods, apparatuses and articles of manufacture for packaging for foodstuffs. cartridges. A cartridge in accordance with an aspect of the present disclosure comprises a cartridge body, a filter, a beverage material, and a cover.

### BACKGROUND

The present disclosure pertains generally to devices and methods related to environmental quality, and more particularly to methods and apparatuses for reduction of landfill materials.

In recent years, single-serve beverage brewers (e.g., those made by Keurig Green Mountain, Inc., of Waterbury, Vt. and other manufacturers) have become popular among consumers. Single-serve beverage brewers, with their corresponding specialized packages of coffee, tea, or other beverage materials, have become a significant segment of the beverage industry.

Single-serve brewers may employ specialized cartridges, e.g., cartridges with a particular shape, encoded with special characters or codes, etc., such that only certain cartridges may be employed in a particular brewer. These cartridges (also referred to as a “container,” “single-serve cartridge,” “pod,” or “beverage cartridge” herein herein) contain a beverage medium, e.g., coffee grounds, tea leaves, cocoa mix, dried soup, etc., for mixing with an incoming fluid (often heated water) to make a beverage. Such a cartridge may be also referred to as a “K-cup®,” “Nespresso® pod,” or soft pod. In some cartridges, the coffee grounds or other beverage medium can be held within, above, or on a filter within the cartridge if desired. Although referred to as “single-serve” cartridges, such cartridges may provide multiple servings of a beverage.

The specialized package of coffee, tea, or other beverage materials used in single-serve brewers is most often a closed plastic cup with the beverage material inside, sealed with aluminum foil or other type of cover. Specialized inks are used to print on the plastic and/or aluminum foil to indicate the type of beverage material inside, lot numbers, etc. The cover is often attached to the plastic cup with an adhesive. The cartridges may include a filter inside the plastic cup to reduce and/or minimize the amount of beverage material (e.g., coffee grounds, tea leaves, etc.) that are transferred from the cartridge to a mug, cup, and/or other receptacle that a person would use for drinking the resultant beverage. The cartridges may also be pressurized with an inert gas, such as nitrogen or carbon dioxide, to reduce oxidation and/or other degradation of the beverage material prior to use in the single-serve brewer.

To make a beverage, heated fluid, often water, is delivered under pressure to the cartridge via one or more inlet needles, and after the fluid passes through the beverage material is removed from the cartridge via an exit nozzle. As such, the cartridge must be able to withstand the operational temperatures and pressures that are present during brewing. However, current cartridges cannot withstand temperatures much over 190 degrees Fahrenheit, because the plastic cup melts at such temperatures.

Over pressurization of the single-serve cartridge may cause the cartridge to rupture. If pressure inside of the cartridge becomes too great, i.e., greater than 3 pounds per square inch over atmospheric pressure, the adhesive between the plastic cup and cover may be breached, the cover may rupture, and/or the cup portion of the cartridge may crack, causing the beverage material and/or fluid to overflow. Such events, sometimes referred to as “blowouts,” may also occur if the beverage material (e.g., coffee grounds, tea leaves, etc.) enter the conduits that are designed to carry fluid, which creates a flow stoppage in the single-serve brewer. Since the pump continues to pump fluid into a blocked conduit, greater than normal pressure is exerted on areas within the brewing system, and the fluid is expelled from the single-serve brewer in undesirable locations.

Because the cartridge is also exposed to heat from the fluid, and in direct contact with the heated fluid, consumers are concerned that the materials used in manufacturing the plastic cup may break down under the heat and pressure of the single-serve brewer. Plastic is a polymer matrix; at single-serve brewer operational temperatures, portions (monomers) of the polymer chain disengage from the polymer matrix. These monomers are in direct contact with a heated liquid that leaches the monomers into the liquid, and thus may be delivered along with the liquid into a beverage. The consumer may then ingest these chemicals, e.g., Bisphenol-A (BPA), other monomers, or other potentially hazardous substances, without being aware that they are doing so.

After the brewing process, plastic cartridges are difficult to recycle. The design of some cartridges does not allow for easy and/or convenient separation into recyclable, non-recyclable, and/or compostable components. Since approximately twenty billion single-serve containers are produced each year, this design oversight may contribute greatly to environmental issues. Some approaches have been made to make the plastic cup portion out of a material that is recyclable. For example, rather than using “#7” (Other) plastic material, suggestions have been made to use polypropylene (PP) which is a “#5” material and acceptable as recycling in many locales. However, such an approach does not fully address the recycling issue, as the cartridge is still not readily disassembled to recycle the plastic portion. Further, PP still suffers from monomer breakdown and potential health risks associated with plastic cartridges. Most recycling centers cannot accept such small pieces of plastic for recycling, which makes the recycling approach less than desirable.

### SUMMARY

Aspects of the present disclosure comprise methods and apparatuses for aiding in the recyclable and/or compostable nature of the materials present in single-serve beverage cartridges. Other aspects of the present disclosure comprise reducing health and environmental risks associated with current single-serve cartridges.

A method for reducing landfill mass in accordance with an aspect of the present disclosure comprises selecting a body material for a foodstuff container, the body material consisting essentially of at least one of plant fibers, pulp material, and a combination thereof, selecting a cover material, forming a container body from the body material, forming a cover from the cover material, placing a foodstuff inside the container body, coupling the container body to the cover, and protecting the foodstuff inside the container body from at least oxidizing contaminants external to the container through the coupling of the container body to the cover.

Such a method further optionally includes the cover material consisting essentially of at least one of plant fibers, pulp material, and a combination thereof, the foodstuff is a beverage material, the beverage material is coffee grounds, the foodstuff container is a beverage cartridge, the foodstuff container is capable of withstanding an internal pressure of greater than 2 Bar, and a designated use of the foodstuff container begins a process of decomposition of the foodstuff container.

A device for reducing landfill mass in accordance with an aspect of the present disclosure comprises a container body, a cover, and a foodstuff, contained inside of the container body; a body material for the container body being selected from a group consisting essentially of at least one of plant fibers, pulp material, and a combination thereof, such that the foodstuff inside the container body is protected from at least oxidizing contaminants external to the container by coupling the container body to the cover.

Such a device further optionally includes the cover material consisting essentially of at least one of plant fibers, pulp material, and a combination thereof, the foodstuff is a beverage material, the beverage material is coffee grounds, the container is a beverage cartridge, the container is capable of withstanding an internal pressure of greater than 2 Bar, and a designated use of the container begins a process of decomposition of the foodstuff container.

The above summary has outlined, rather broadly, some features and technical advantages of the present disclosure in order that the detailed description that follows may be better understood. Additional features and advantages of the disclosure will be described below. It should be appreciated that this disclosure may be readily utilized as a basis for modifying or designing other structures for carrying out the same purposes of the present disclosure. It should also be realized that such equivalent constructions do not depart from the teachings of the disclosure. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

FIG. 1 is a schematic view of one embodiment of a beverage system according to an aspect of the present disclosure;

FIG. 2 illustrates a beverage cartridge in accordance with an aspect of the present disclosure;

FIG. 3 illustrates a method for recycling a beverage cartridge as described in the related art.

FIG. 4 illustrates a cross-sectional view of a single-serve beverage cartridge in accordance with an aspect of the present disclosure.

FIGS. 5 and 6 illustrate exploded perspective views of a single-serve beverage cartridge in accordance with an aspect of the present disclosure.

FIG. 7 illustrates a cross-sectional view of a single-serve beverage cartridge in accordance with an aspect of the present disclosure.

FIG. 8 illustrates a controller in accordance with an aspect of the present disclosure.

FIG. 9A illustrates a cross-sectional view of a beverage cartridge in accordance with an aspect of the present disclosure.

FIG. 9B illustrates a top view of a beverage cartridge in accordance with an aspect of the present disclosure.

FIG. 10 illustrates a filter design in accordance with an aspect of the present disclosure.

FIG. 11 illustrates a filter design in accordance with an aspect of the present disclosure.

FIG. 12 illustrates a beverage cartridge in accordance with an aspect of the present disclosure.

FIG. 13 illustrates a beverage cartridge in accordance with an aspect of the present disclosure.

FIG. 14 illustrates a beverage cartridge in accordance with an aspect of the present disclosure.

FIG. 15 illustrates a beverage brewing system in accordance with an aspect of the present disclosure.

FIG. 16 illustrates a system in accordance with an aspect of the present disclosure.

FIGS. 17 and 18 illustrate operation of a beverage brewing system in accordance with an aspect of the present disclosure.

FIG. 19 illustrates a table of brewing ratios for different types of coffee in accordance with an aspect of the present disclosure.

FIG. 20 illustrates a process flow in accordance with an aspect of the present disclosure.

### DETAILED DESCRIPTION

The present disclosure is directed toward packaging able to withstand the operational conditions of single-serve brewing devices that are also more readily recycled and/or composted than current cartridges. A single-serve cartridge in accordance with an aspect of the disclosure also may mitigate health risks associated with current cartridge materials.

Embodiments of the disclosure are described herein with reference to cross-sectional view illustrations that are schematic illustrations of embodiments of the disclosure. As such, the actual dimensions of elements can be different, and variations from the shapes of the illustrations as a result, for example, of manufacturing techniques and/or tolerances are expected. Embodiments of the disclosure should not be construed as limited to the particular shapes of the regions illustrated herein but are to include deviations in shapes that result, for example, from manufacturing. A region illustrated or described as square or rectangular may have slightly rounded or curved features due to normal manufacturing tolerances. Thus, the regions illustrated in the figures are schematic in nature and their shapes are not intended to illustrate the precise shape of a region of a device and are not intended to limit the scope of the disclosure. It is understood that the shapes, sizes, and locations in the attached figures may not be to scale.

### Overview

A single-serve cartridge in an aspect of the present disclosure may withstand broader operational characteristics, e.g., temperature, pressure, etc., than current cartridges. Such a cartridge may prevent and/or reduce blowouts and/or other over pressurization issues, which may increase clean-up efforts and endanger users.

The present disclosure, in an aspect of the present disclosure, may mitigate the lack of sustainable design for single-serve beverage cartridge (e.g., K-cup®) materials and designs. An embodiment of the present disclosure seals the filter and the cover together, with the beverage material inbetween. This assembly may be removed from the external cup (also referred to as “container” herein) and the beverage material is then contained within the assembly. The external cup is then completely separated from the cover, filter, and beverage material, and could be recycled. The cover/filter/beverage material can be composted or discarded as desired. Through selection of the adhesives or methods of attachment used to attach the cover to the filter, and the combined cover/filter to the plastic cup, pulling on the cover will separate the cover/filter from the external cup as a unit. This aspect of the present disclosure allows the beverage material to be removed as a whole, and maintains the convenience of the single-serve cartridge design while introducing conservation and ecological sustainability into single-serve beverage systems.

In another aspect of the present disclosure, the external cup materials may be altered to reduce and/or eliminate leaching of monomers into the resultant beverage. Current external cup materials employ plastic materials for the external cup, which when exposed to operational temperatures of single-serve brewing systems will leach various undesirable materials into the beverage to be consumed.

### System Description

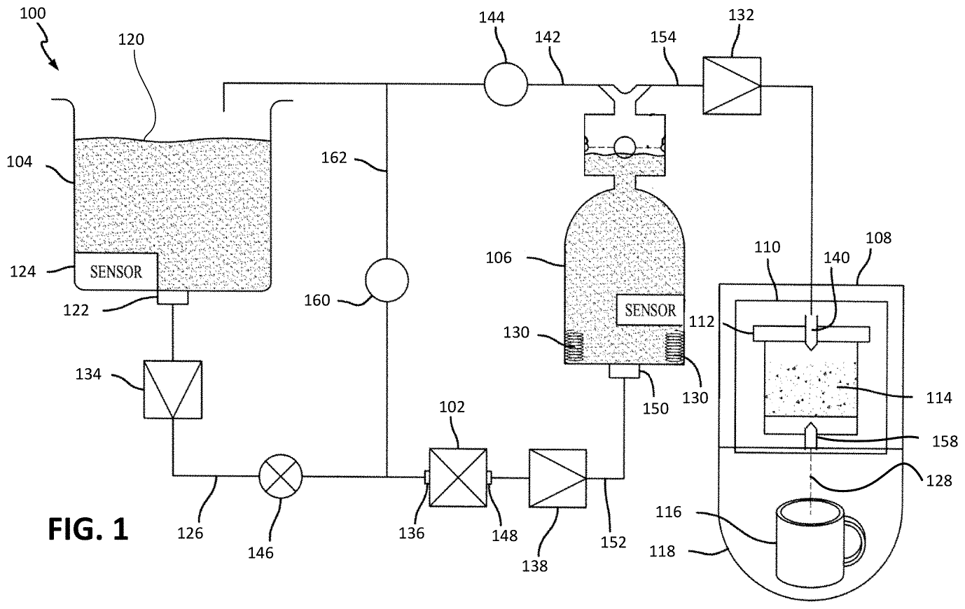

FIG. 1 is a schematic view of one embodiment of a beverage system according to an aspect of the present disclosure. In an aspect of the present disclosure, system 100, includes pump 102 that can be configured to pump unheated fluid, e.g., water, from a reservoir 104 to a heater 106, which heats the water to a desired temperature for delivery to a brew head 108. The brew head 108 includes a receptacle 110 that can house a cartridge 112 containing a single-serve or a multi-serve amount of a beverage material 114, e.g., coffee grounds, tea, hot chocolate, lemonade, etc., for producing a beverage dispensed from the brew head 108. The beverage can be dispensed into a container 116, e.g., mug, carafe, etc. which can be placed on a platen 118. Although the present disclosure refers to cartridge 112 and beverage material 114, any container, e.g., can, bottle, etc., may be substituted for cartridge 112, and/or any foodstuff, e.g., solid, liquid, etc., may be substituted for beverage material 114, without departing from the scope of the present disclosure.

The reservoir 104 may store fluid 120, e.g., ambient temperature water, that may be used to brew a serving and/or multiple servings of beverage (e.g., coffee) in accordance with the embodiments and processes disclosed herein. The fluid 120 may exit the reservoir 104 during the brew process via an outlet 122 at the bottom of reservoir 104. The fluid 120 may exit the reservoir 104 from locations other than the bottom, such as the sides or the top such as via a reservoir 104 pickup extending down into the reservoir 104, or other locations as desired or feasible. In an aspect of the present disclosure, the reservoir 104 includes a water level sensor 124 and/or other sensors (not shown) to detect whether the reservoir 104 is sealed by the lid, has a low water level, or other conditions, and may interact with brewer 100 circuitry to prevent initiation of a brew cycle in the event there are undesirable conditions present in brewer 100. The reservoir 104 may be replaced by other fluid 120 sources, such as a water tap connection.

In an aspect of the present disclosure, the pump 102 pressurizes and/or pumps fluid 120 from the reservoir 104 to the cartridge 112 and/or pumps air to purge remaining fluid 120 and/or brewed beverage from the beverage system 100. In such an aspect, the pump 102 initially pumps fluid 120 from the reservoir 104 through a first conduit 126 to the heater tank 106 where the fluid 120 is heated to a predetermined temperature before delivery to the cartridge 112 to brew the beverage material 114 into beverage 128. At, near, or after the end of the brew cycle, the pump 102 pumps air through the beverage system 100 to purge any remaining fluid 120 or beverage 128 in brewing system 100. As such, the pump 102 is able to operate in both wet and dry conditions, i.e., the pump 102 can switch between pumping water and air without undue wear and tear, although separate pumps for water and air are possible without departing from the scope of the present disclosure. Many variables exist within brewing system 100 that may affect the overall performance of brewing system 100. Each of these variables may be at least partially accounted for through processor 800 to produce a more consistent performance in beverage system 100.

Once pierced by nozzle 140, each cartridge 112 provides resistance to the flow of fluid through cartridge 112 to mug 116. This resistance varies based on, among other things, the beverage medium within cartridge 112. For example, and not by way of limitation, bouillon within cartridge 112 may provide less resistance to fluid flow than ground coffee, because bouillon dissolves in the heated fluid 120 from nozzle 140 while coffee grounds do not.

The pressure drop across the beverage material 114 can result in back pressure against the outlet of check valve 132. If this back pressure is high enough (e.g., equal to or greater than the difference in pressure between the inlet and outlet of the check valve 132), check valve 132 may close, or cartridge 112 (or filter paper that is internal to cartridge 112) may be “blown out” by the pressure created by the incoming pressure of the heated fluid through nozzle 140.

### Cartridge Construction

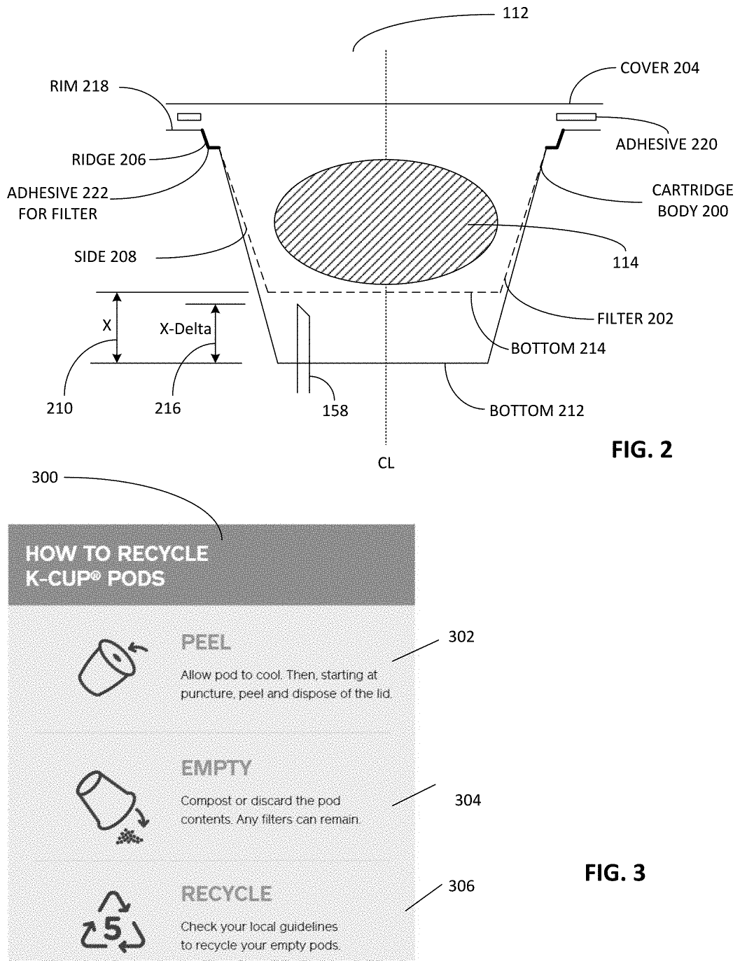

FIG. 2 illustrates a beverage cartridge in accordance with an aspect of the present disclosure. Cartridge 112 comprises a cartridge body 200, a filter 202, and a cover 204. Although current cartridge bodies 200 are made from various types of plastic, in an aspect of the present disclosure, cartridge body 200 may comprise of a cellulose-based material. Cartridge body 200 may be made of paper, pulp, cellulose and/or celluloid material, plant fibers, or other natural, renewable, recyclable, recycled, and/or compostable products, and may have an optional binding material, e.g., starch, lignin, sugar, adhesive, or be processed chemically to allow for various structures of cover 204 as desired. For example, and not by way of limitation, a specific pulp and, if desired, a specific binding material may be used to provide a specific quality of the cover 204, e.g., easy piercing, extra strength, ease of printing, etc., while other covers 204 may employ a different pulp and, if desired, a different binding material for a different application.

Filter 202 is inserted into cartridge body 200 and may be adhered to cartridge body 200 at ridge 206. Sides 208 of filter 202 may be pleated or otherwise shaped to fit within a shape of cartridge body 200. For example, and not by way of limitation, cartridge body 200 may be frustoconical in shape, and filter 202 may be pleated along the sides 208 such that the top of filter 202 sides 208 may be adhered to ridge 206 while sides 208 are proximate the frustoconical shape of the cartridge body 200. The shape and/or depth of filter 202 allows for a space 210 (“X”) to reside between a bottom 212 of cartridge body 200 and bottom 214 of filter 202. Space 216, (“X-Delta”) is the depth to which outlet needle 158 penetrates into cartridge body 200. Space 210 is often larger than space 216, to ensure that outlet needle 158 does not pierce filter 202, which would allow beverage material 114 to be delivered out of outlet needle 158 to mug 116 (as shown in FIG. 1).

Cover 204 is adhered to rim 218 with adhesive 220. Adhesive 220, and adhesive 222 used to adhere filter 202 to cartridge body 200, may be a sonic welding adhesion, a compression and/or fusing of filter 202 to cartridge body 200, and/or an adhesive material, which couples cover 204 to cartridge body 200. Cover 204 may be made of paper, pulp, cellulose and/or celluloid material, plant fibers, or other natural, renewable, recyclable, recycled, and/or compostable products. Cover 204 may have an optional binding and/or filler material, e.g., starch, lignin, sugar, adhesive, or be processed chemically to allow for various structures of cover 204 as desired. For example, and not by way of limitation, a specific pulp and, if desired, a specific binding material may be used to provide a specific quality of the cover 204, e.g., easy piercing, extra strength, ease of printing, etc., while other covers 204 may employ a different pulp and, if desired, a different binding material for a different application.

Cover 204 may provide a substantially air-tight seal such that beverage material 114 (or other packaged material, foodstuff, etc. inside of cartridge 112) is not exposed to air, which may oxidize beverage material (or other foodstuffs). Cover 204 may also provide water resistance depending on the materials used for cover 204. Further, cover 204, when adhered to and/or mechanically coupled to cartridge body 200, may allow for an inert gas, such as nitrogen, to be contained within cartridge 112 to further reduce oxidation and/or other degradation of beverage material 114 between the time beverage material 114 is packaged in cartridge 112 and used in brewing system 100. Such a reduction in degradation of beverage material 114 may improve the flavor and/or consistency of beverage 128 produced in brewing system 100.

### Cartridge Body Material

Cartridge 122, and in particular cartridge body 200, is often made from plastic. Plastic materials may be categorized to by their “recycling number” which is often stamped or otherwise imprinted on plastic materials to indicate the type of plastic used in making a specific container. Depending on the recycling number, plastic materials may or may not be recyclable.

Plastic #1, Polyethylene Terephthalate (sometimes referred to as “PETE” or “PET”), is often clear or transparent and used to make soda and/or water bottles. Plastic #2, High Density Polyethylene, (sometimes referred to as “HDPE”) is often opaque, and may be used to manufacture milk jugs, household cleaner containers, juice bottles, shampoo bottles, and box liner bags. Plastic #3, vinyl (also known as polyvinylchloride, or referred to as “V” or “PVC”), may be used in food wrapping materials, plumbing pipes, and detergent bottles. Plastic #4, Low Density Polyethylene (sometimes referred to as “LDPE”) may be found in squeezable bottles, shopping bags, and/or food wrapping materials.

Plastic #5, Polypropylene (also referred to as “PP” or “polypro”) may be used in making yogurt containers, and/or food packaging bottles. Plastic #6, Polystyrene (sometimes referred to as “PS” or “Styrofoam”) may be found in compact disc cases, egg cartons, meat trays, and/or disposable plates and cups. Plastic #7 is a “miscellaneous” category, where plastic resins or mixtures of plastic resins that do not fit into categories 1-6 are placed. Plastic #7 may include polycarbonates, and may be used to manufacture sunglasses, computer cases, nylon, and/or other goods.

Depending on the material used to manufacture cartridge body 200, cartridge body 200 may be recyclable. Although all plastics are theoretically recyclable, many curbside recycling programs will not accept some plastics, e.g., plastic #6, plastic #7, etc., as recyclable materials.

Further, some plastics may contain chemicals that may leach from the body 200 material under certain conditions. For example, plastic #3 may contain Bis(2-ethylhexyl) adipate, or DEHA. DEHA has been demonstrated to induce liver adenomas and carcinomas in mice, and many people consider DEHA to be a human health risk. As another example, plastic #7 may contain bisphenol-A (BPA). BPA is also potentially toxic in humans, as BPA is considered to be a hormone disruptor linked to infertility, hyperactivity, reproductive problems, and other health issues.

Depending on the brewing system 100, several different beverages 128 may be produced. Many brewing systems are able to recognize differences in cartridge 112 to change the brewing conditions, including brewing time, temperature, and pressure. To brew coffee, for example, fluid 120 may be heated to 190° F. and introduced into cartridge 112 for several minutes at a lower pressure, e.g., 1-5 pounds per square inch (psi), although the pressures can be higher or lower than those listed. For espresso-style beverages 128, fluid 120 may be heated to approximately 210° F. and introduced into cartridge 112 for a shorter period of time at a higher pressure, e.g., 8-20 bar (100-280 pounds per square inch (psi)), although the pressures can be higher or lower than those listed. Some brewing processes may include fluid 120 temperatures above 212° F. when steam is injected through nozzle 140. These time, temperature, and pressure variables may also be user-selected. As such, cartridge 112, and thus cartridge body 200, may be exposed to a range of temperatures and pressures, and the range of temperatures and pressures may or may not be known prior to cartridge body 200 use. Further, such temperatures and/or pressures may cause degradation of the cartridge body 200 plastic material, resulting in distortion of the cartridge body 200 shape and/or release of leached materials from the cartridge body 200 into the beverage 128.

Cellulose-based materials that may be employed for the cartridge body 200 in an aspect of the present disclosure include, but are not limited to, recycled paper, paper, organic materials such as plants, etc., and other materials. Such materials may include binding material, such as starches, glue, etc., and/or materials that increase the ability of cartridge body to withstand the conditions of brewer 100.

FIG. 3 illustrates a method for recycling a beverage cartridge as described in the related art. As shown in FIG. 3, a process 300 for recycling K-cup® cartridges 112 (also known as “pods”) is illustrated. Block 302 indicates that cover 204 should be peeled from cartridge body 200 after cartridge 112 has cooled. Cover 204 is grasped by the puncture (hole) in cover 204 made by inlet nozzle 140 and removed from cartridge body 200. Cover 204 is to be disposed after removal.

In block 304, beverage material 114 is to be emptied from cartridge body 200. Beverage material 114 may be composted or disposed of. Filter 202 (not shown in FIG. 3) is described as remaining in cartridge body 200.

In block 306, cartridge body 200 is described as being made from Plastic #5, which is polypropylene, and can be recycled once cover 204 is removed and beverage material 114 is emptied out of cartridge body 200.

However, the related art as shown in FIG. 3 does not provide a time-effective and/or method for recycling cartridge body 200. The user must remove the cover 204 from a hole that is approximately 0.2 inches in diameter, which is inconvenient, and remove the beverage material 114 separately. Further, the cover 204 is difficult to remove from the cartridge body 200 in a single piece, since the user will likely tear out a section of cover 204 from the puncture towards the edge of cover 204. Having to remove the beverage material 114 separately from the cover merely adds to the inconvenience of the related art method.

Further, and perhaps more importantly, the related art method does not address the deformation or leaching of cartridge body 200 during the operational conditions of beverage system 100. Current cartridge body 200 materials, which are plastic #7, may deform from their original thermoplastically-set shape when exposed to fluid 120 at 205° F. Plastic #5, which may have a higher melting point than plastic #7, still may leach materials into beverage 128. Nothing is mentioned in the related art about binders and/or fillers that may be included in plastic #5 when used in cartridge body 200, and how these binders and/or fillers may also be leached into beverage 128.

The physical processes that occur during thermal breakdown of polymers and/or plastics depends at least in part on the material being used. Further, thermosetting and thermoplastic materials do not often have a well-defined phase transformation at a specified temperature. Instead, thermoplastic and thermosetting materials have a second-order transition between solid and liquid phases.

For example, and not by way of limitation, thermosetting and thermoplastic materials do not have a single transition curve. Polypropylene (Plastic #5) is 65% crystalline, and has a crystalline melting temperature of 170 degrees Centigrade. Because polypropylene is not 100% crystalline, it is considered as partially amorphous and, thus, is a fluid that, over periods of time, will flow into different shapes and has internal flow within the structure, even at room temperatures. This characteristic of polypropylene, and/or other thermosetting and thermoplastic materials, is similar to window glass, as both materials are amorphous.

For amorphous and/or semi-amorphous materials, the transition from a glass state to a soft and/or malleable state is called the glass-transition region, and begins occurring at a temperature known as the glass transition temperature. This property of thermoplastic materials is what allows these materials to be formed through the use of heat, and then cooled to the point where they are rigid and in the desired shape. As an example, the cartridge body 200 may begin as a flat sheet of plastic, but is formed into the frustoconical shape of the cartridge body 200 by addition of heat and/or pressure to form the shape of cartridge body 200. Depending on the binding and/or filler materials used, the “polypropylene” material may have a large number of transition curves and thus leach at different rates for a given temperature.

Many materials also desorb adsorbed fluids (e.g., water) at elevated temperatures. The activation energy for physical desorption of water is 30-40 kilojoules (kJ) per mol, and desorption begins occurring at temperatures below 212° F. Polypropylene has a glass transition temperature of negative 4 (−4)° F. This means that at room temperature polypropylene has internal fluidic migrations of materials, i.e., the 35% of material in polypropylene that is not crystalline, even though these migrations are not visible to the human eye.

Further, when cartridge body 200 is exposed to the operational conditions of brewing system 100, cartridge body 200 may be in direct contact with fluid 120 at temperatures between 145-212° F. for several minutes. The fluidic motion of the non-crystalline materials within cartridge body 200, as well as the crystalline polypropylene itself, and/or any fillers and/or binders used in cartridge body 200, would thus be raised even further above the glass transition temperature, and become fluid in the classical sense. The fluid 120 is also pressurized against the cartridge body 200, and the combination of pressure and temperature conditions present in brewing system 100 may create leaching of some of the cartridge body 200 material and/or the fillers and/or binders present in the cartridge body 200 material into beverage 128.

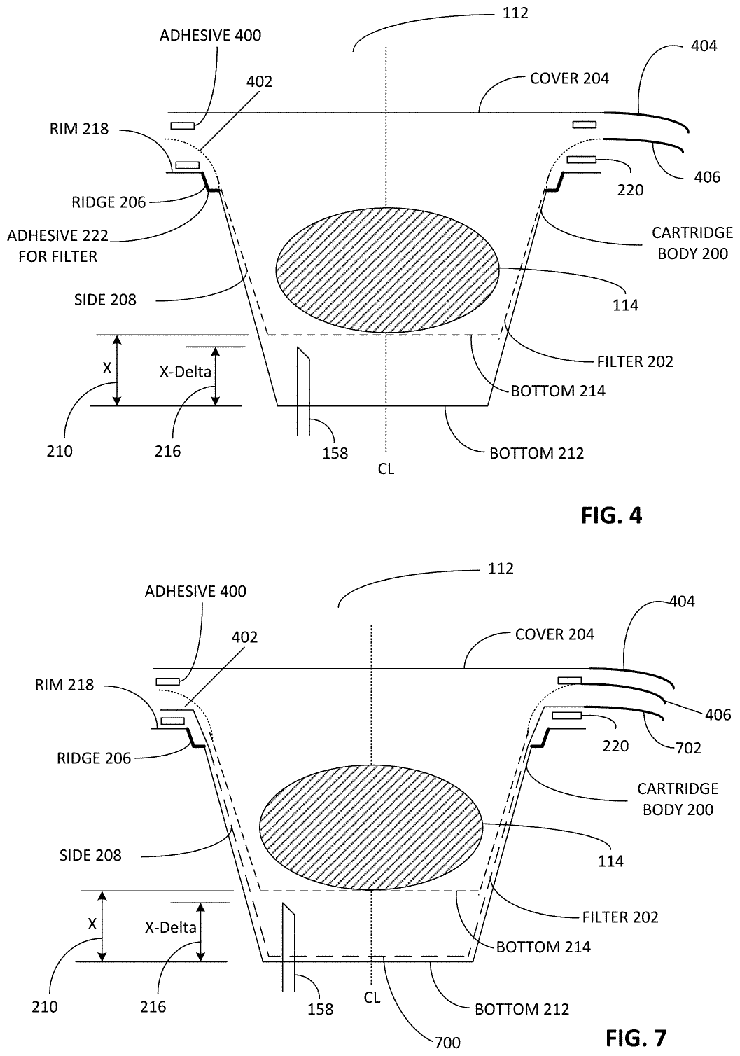

FIG. 4 illustrates a cross-sectional view of a single-serve beverage cartridge in accordance with an aspect of the present disclosure. In FIG. 4, filter 202 may be attached to cover 204 by adhesive 400. Cover 204 may also be made of a cellulose-based material, and may be made of a different cellulose-based material than cartridge body 200 without departing from the scope of the present disclosure. Portion 402 of filter 202 is then coupled to rim 218 of cartridge body 200, rather than being coupled to ridge 206. This may simplify the manufacture of cartridge 112, as filter 202 may be coupled to cover 204 prior to attachment of the then combined filter 202/cover 204 to cartridge body 200. For example, and not by way of limitation, beverage material 114 may be sandwiched in a pod comprising filter 202 and cover 204 (as well as other layers of material if desired), and these pods may then be coupled to rim 218 of cartridge body 200. As long as the bottom 214 of filter 202 would not be pierced by needle 158, the attachment of filter 202 to cover 204 rather than to the ridge 206 of cartridge body 200 is not critical to the operation of cartridge 112 in beverage system 100.

Because single-serve cartridges 112 are designed to be pierced on the bottom 212 of cartridge body 200, filter 202 is designed to hold beverage material 114 above the level of the needle 158 at all locations. If cartridges 112 were designed to be pierced on the cover 204 for both the inlet nozzle 140 and the outlet needle 158, e.g., Nespresso® cartridges, filter 202 would have no such restriction for having a bottom 214 that sits a distance 210 away from bottom 212. Some cartridges 112 may not need a filter 202 at all, such as Nespresso® cartridges.

Some cartridges that may be used for multi-serve brewing, such as K-carafe® cartridges, are designed to be pierced on the cover by a second needle for delivering the beverage 128 to mug 116 and are not pierced on the bottom by outlet needle 158. Such cartridges are not considered single-serve cartridges 112, and are not compatible with all brewing systems 100 in the single-serve brewing market. Further, such multi-serving and/or multi-serve cartridges have not been as well accepted in the marketplace as the single-serve cartridges 112 that are pierced on the bottom 212 of cartridge body 200, because the multi-serve cartridges are less convenient than the single-serve cartridges 112. However, such multi-serve cartridges are also considered to be “single-serve” cartridges 112 for the purposes of this disclosure.

Adhesive 400 may be the same adhesive material as adhesive 220, or may be a different adhesive depending on the materials used in filter 202, cover 204, and cartridge body 200, and/or other considerations as desired. In an aspect of the present disclosure, cover 204 may include tab 404, which extends beyond an outer circumference of rim 218 of cartridge body 200. Tab 404 provides a gripping surface for cover 204, such that cover 204 may be removed from rim 218, rather than attempting to pull cover 204 away from rim 218 via a pierced hole as described with respect to FIG. 3.

Since cover 204 is now coupled to filter 202, pulling tab 404 may separate filter 202 and cover 404 from cartridge body 200 together, rather than leaving filter 202 in cartridge body 200 as described with respect to FIG. 3. Further, because filter 202 and cover 404 are coupled together, either via adhesive 400 and/or by other methods, beverage material 114 is contained within the combination of filter 202 and cover 204. In many beverage systems 100, beverage material 114 has been purged of most of the fluid 120 used to brew beverage 128 by pumping air through beverage material 114, so removing beverage material 114 along with filter 202 and cover 204 is easier to perform than the method described in FIG. 3.

In an aspect of the present disclosure, exposure to water or other fluids may begin the decomposition process of a cartridge 112, by using the acids or other naturally-occuring chemicals present during brewing of a beverage, to assist in the breakdown of the bonds formed when the cartridge 112 was made. For example, and not by way of limitation, a cartridge body made from paper may begin organic decomposition when acids in coffee come in contact with the paper cartridge 112, such that when cartridge 112 is composted, the composting process was started and aided by use of the cartridge for one of its intended purposes.

In a further aspect of the present disclosure, filter 202 may be made from a biodegradable material, compostable material and/or cellulose-based material. Cover 204 may also be made from a biodegradable material, compostable material and/or cellulose-based material. For example, and not by way of limitation, filter 202 may be made from paper, and cover 204 may be made from a biodegradable plastic or plant-based material. As such, the combination of filter 202, cover 204, and beverage material 114 may be entirely biodegradable, compostable, and/or recyclable. Once separated from cartridge body 200, the combination of filter 202, cover 204, and beverage material 114 may then be used as compost, while cartridge body 200 may then be recycled as plastic and/or other compostable material such as paper. Such an approach is far simpler, and far more environmentally-friendly, than the related art approach of FIG. 3.

In another aspect of the present disclosure, filter 220 may comprise tab 406, either alternatively or in conjunction with tab 404 of cover 204. Tab 406 allows for filter 202 to be pulled or otherwise separated from cartridge body 200 when the combination of filter 202, cover 204, and beverage material 114 are removed from cartridge body 200. Tabs 404 and/or 406 may provide additional strength to the bond, connection, and/or coupling between filter 202 and cover 204, and an additional means for providing force to remove the combination of filter 202, cover 204, and beverage material 114 from cartridge body 200.

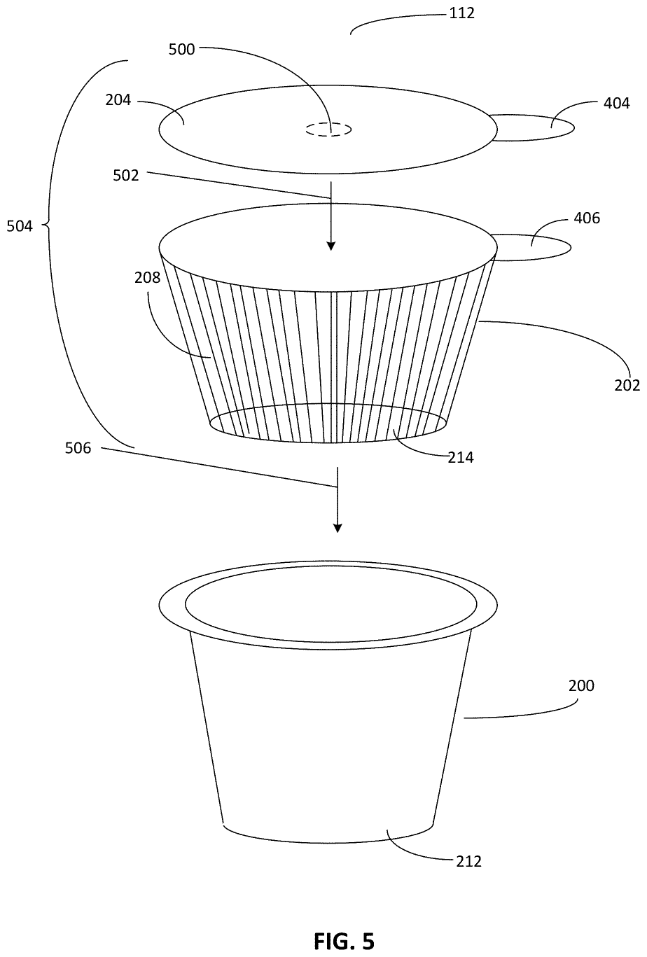

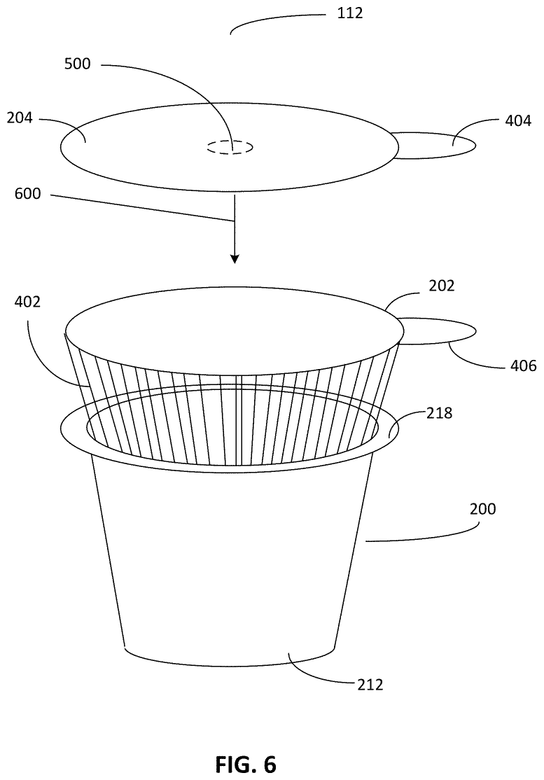

FIGS. 5 and 6 illustrate exploded perspective views of a single-serve beverage cartridge in accordance with an aspect of the present disclosure. Cartridge 112 is shown with cover 204, filter 202, and cartridge body 200. Tabs 404 and 406 are shown, however, as described above, aspects of the present disclosure may have only one of such tabs 404 and/or 406 present as desired. Sides 208 of filter 202 are shown as being pleated in FIG. 5, although such pleating is optional in any aspect of the present disclosure. Cover 204 may be, for example, a metal foil cover, while cartridge body 200 is a cellulose-based material. The materials for cartridge body 200 and cover 204 may be selected based on the application and expected conditions of cartridge 112.

A location where inlet nozzle 140 may pierce cover 204 is shown as location 500. Cover 204 may be coupled to filter 202 as shown by arrow 502. This may make a combined unit 504, which may then be inserted into cartridge body 200 as shown by arrow 506. As shown in FIG. 6, part of filter 202, i.e., portion 402, may overlap rim 218. As cover 204 is coupled to filter 202, either as shown by arrow 600 or as a unit 504 described with respect to FIG. 5, cover 204 is coupled to rim 218 of cartridge body 200. Tabs 404 and/or 406 may be used to remove filter 202 and cover 204 from cartridge body 200 while allowing filter 202 and cover 204 to substantially remain coupled together.

FIG. 7 illustrates a cross-sectional view of a single-serve beverage cartridge in accordance with an aspect of the present disclosure. As with FIG. 4, filter is not coupled to ridge 206 as in the related art. In the aspect of the present disclosure shown in FIG. 7, a liner 700 is placed between the inner surface of cartridge body 200 and filter 202. Liner 700 may comprise tab 702, which may be used alone or in conjunction with tabs 404 and 406 as described with respect to FIG. 4.

Liner 700 limits the direct contact between fluid 120 that is introduced into cartridge 112 and cartridge body 200. Because cartridge body 200 may leach chemicals and/or other materials into beverage 128, and be delivered via needle 158, liner 700 reduces the possibilities that such leaching will occur. Although heated fluid 120 will still likely leach material from cartridge body 200 through thermal exchange with cartridge body 200, liner 700 reduces and/or eliminates the pathways for such leached material from exiting cartridge 112 through needle 158 as part of beverage 158. Although liner 700 is shown as being substantially similar in shape to cartridge body 200, e.g., conforming to the side and bottom of cartridge body 200, liner 700 may take any shape as desired that limits the contact between fluid 120 and the inner wall of cartridge body 200.

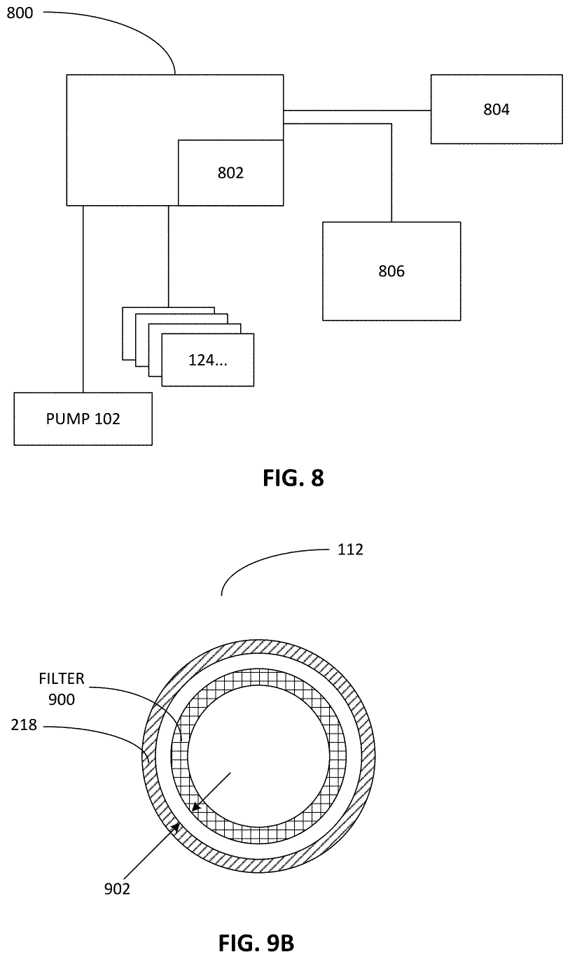

FIG. 8 illustrates a controller in accordance with an aspect of the present disclosure. The brewer 10 can include a controller or other processing unit, such as a microcontroller 800, shown schematically in FIG. 8. The microcontroller 800 may include an internal memory 802 and/or external memory 804 and can serve many different functions. For example, in one embodiment, the microcontroller 102 may serve to regulate the power provided to the pump 102, control system 100 through readings from sensor 124 and/or other sensors within system 100, accept input from user controls 806, or other controlling and/or monitoring functions. Many different functions are possible without departing from the scope of the present disclosure.

The memory, which may be internal memory 802 or external memory 804 to microcontroller 800, may be implemented in firmware and/or software implementation. The firmware and/or software implementation methodologies may be implemented with modules (e.g., procedures, functions, and so on) that perform the functions described herein. A machine-readable medium tangibly embodying instructions may be used in implementing the methodologies described herein. For example, software codes may be stored in a memory and executed by a processor unit (e.g., microcontroller 800). Memory may be implemented within the processor unit or external to the processor unit. As used herein, the term “memory” refers to types of long term, short term, volatile, nonvolatile, and/or other non-transitory memory and is not to be limited to a particular type of memory or number of memories, or type of media upon which memory is stored.

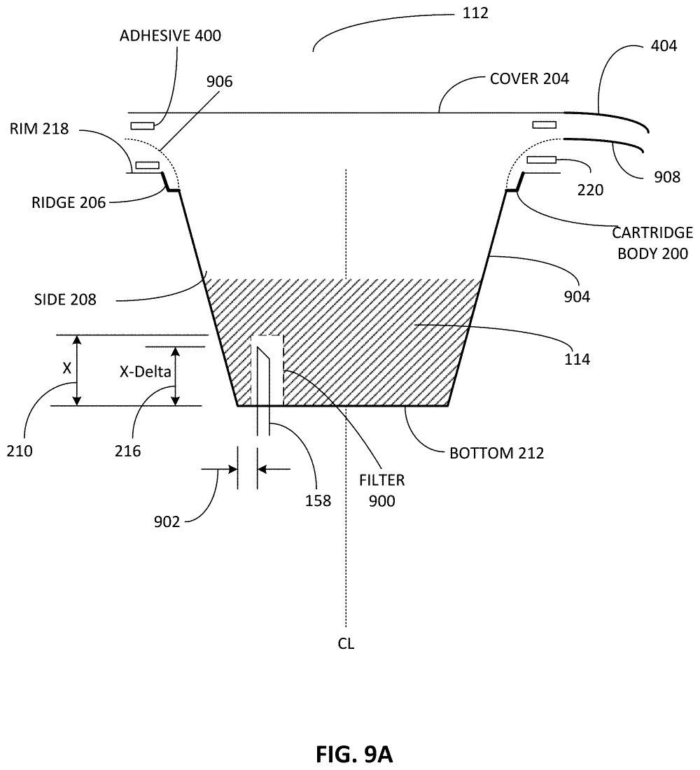

FIGS. 9A and 9B illustrate a recyclable beverage cartridge in accordance with an aspect of the present disclosure. FIG. 9A shows filter 900 located at a distance 900 from side 208 of the cartridge body 200. Distance 902 is a known distance, and may be approximately 0.25 inches, because cartridge body 200 is designed to fit within receptacle 110 in any orientation, and the outlet needle 158 is in a fixed location within receptacle 110. As such, a toroidal volume may be defined by filter 900, having a height at least as high as dimension 216, with a tolerance for the location of the toroid such that filter 900 is not pierced and/or otherwise compromised by needle 158 when needle 158 pierces cartridge body 200.

Further, cartridge body 200 may be made from paper, pulp, cellulose and/or celluloid material, plant fibers, or other natural, renewable, recyclable, and/or compostable products, such that once the cartridge 112 has been used (i.e., nozzle 140 has pierced cover 204 and delivered fluid to cartridge 112 and beverage material 114 to brew a beverage 128), the entire cartridge 112 may be placed in a compost pile rather than separating cover 204 from cartridge body 200. As shown in FIG. 9B, filter 900 covers a cylindrical volume within cartridge 112, such that regardless of the orientation of cartridge 112 when placed in system 100, outlet nozzle 158 will pierce bottom 212 of cartridge 112 on one side of filter 900 while beverage material 114 is on an opposite side of filter 900.

In an aspect of the present disclosure, cartridge body 200 may be made from wood pulp and/or recycled paper products, which may be combined with food-safe binders such as starches and/or sugars, and/or other adhesives and/or binders that are safe for interactions with consumed products. To minimize leaching of flavors or other possibly undesirable liquids and/or solids from cartridge body 200 in such cases, an optional liner 904, which may be made of a different material than cartridge body 200, e.g., metal foil, a different natural, plant, and/or combination of materials, and/or may have a different density than cartridge body 200, such that contact between fluids entering cartridge 112 and cartridge body 200 are reduced when compared to cartridges 112 that do not include optional liner 904. Optional liner 904 may further comprise an optional portion 906 and/or optional tab 908 without departing from the scope of the present disclosure. The inclusion of liner 904 may minimize and/or prevent seepage of any flavors, binders, and/or other by-products from cartridge body 200, similar to how liner 700 minimizes leaching of by-products when cartridge body 200 is made from plastic.

Liners 700 and/or 900 may be made from various materials; metal foil, plastic, paper, natural materials, etc. Liners 700 and/or 900 may provide several advantages and/or functions to cartridge 112. For example, and not by way of limitation, liner 700 and/or 900 may provide a hermetic and/or semi-hermetic seal for a portion of cartridge 112, such that beverage material 114 contained within cartridge 112 is substantially separated from outside air and/or other contaminants or oxidizing materials. Depending on the material used for cartridge 112, cartridge 112 may already provide a hermetic and/or semi-hermetic seal. Further, and not by way of limitation, liner 700 and/or 900, either in addition to or in the alternative, may provide a barrier between any liquid introduced into cartridge 112 and the cartridge body 200, such that the liquid introduced into cartridge 112 does not substantially contact cartridge body 200. Such liners 700 and/or 900 may also prevent any liquids, gasses, or fluids produced by the heat, pressure, and/or other operational conditions within beverage system 100 that are experienced by cartridge 112 from being delivered to mug 116 along with beverage 128.

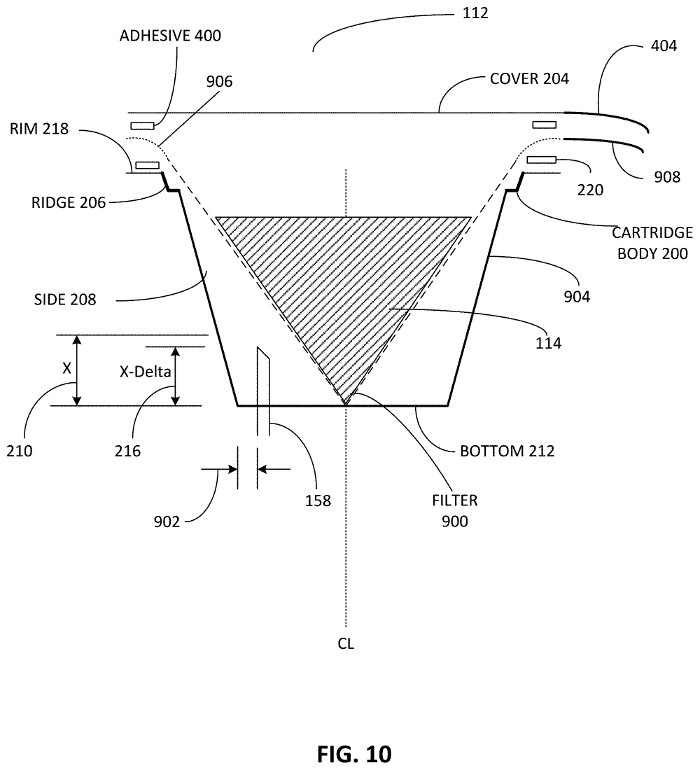

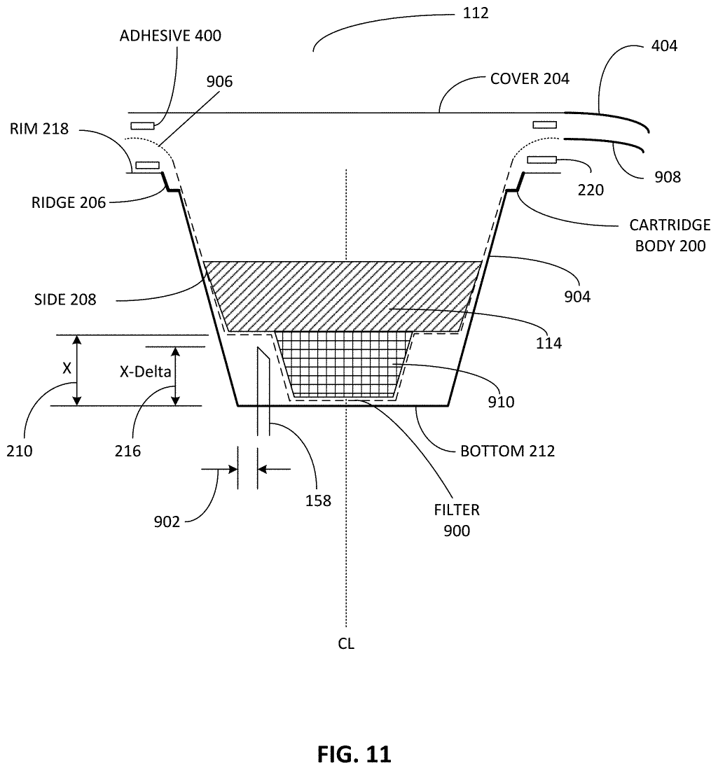

FIGS. 10 and 11 illustrate filter designs in accordance with an aspect of the present disclosure. Filter 900 may take any shape desired, and, as shown in FIG. 10, may be conical in shape rather than adopting the frustoconical shape of cartridge body 200 as shown in FIGS. 2 and 4-7. So long as filter 900 is not pierced by needle 158, filter 900 may take any desired shape, which may alter the brewing considerations and/or possibilities for various beverage materials 114. For example, and not by way of limitation, allowing filter 900 to reach the bottom of cartridge body 200, either as a conical shape shown in FIG. 10 or as a stepped frustoconical shape shown in FIG. 11, fluid introduced into cartridge 112 will remain in contact with beverage material 114 present for a longer period of time before being delivered to mug 116 via needle 158. Further, a different type of beverage material 114 may be placed in volume 910, which may also be separated from beverage material 114 by a second filter, to produce a hybrid-brewed beverage of the two beverage materials 114 present in cartridge 112. Such combinations and/or time duration of fluid/beverage material 114 contact differences are not possible in the related art, as the time duration is driven by fluid flow rates determined by pump 102. By allowing fluid from inlet nozzle 140 to remain in contact with beverage material 114 for a longer period of time, additional and/or other oils, flavors, and/or essences may be removed from beverage material 114 without requiring design changes to beverage system 100 or programming pump 102 to deliver fluid to nozzle 140 at different rates.

### Craft Brewing Techniques

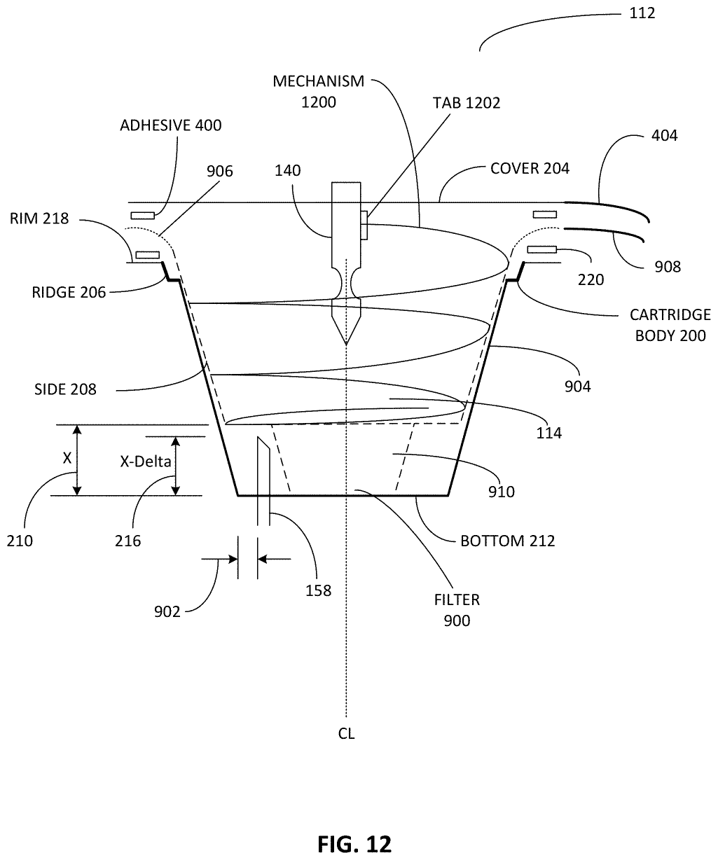

FIG. 12 illustrates a beverage cartridge in accordance with an aspect of the present disclosure. Cartridge 112 may also comprise a mechanism 1200 that may move, tighten, loosen, or otherwise interface with beverage material 114 once inlet nozzle 140 is inserted into cartridge 112. Some systems 100 have inlet nozzles 140 that move and/or rotate after piercing cover 204. Depending on the settings and/or programming of such systems 100, inlet nozzle 140 can rotate in one direction for a first set of settings, and a second direction for a second set of settings. As such, mechanism 1200 may be selectively engaged by inlet nozzle 140 based on the direction of movement and/or rotation of inlet nozzle 140.

For example, and not by way of limitation, inlet nozzle 140 may comprise a tab 1202 that only engages mechanism 1200 when inlet nozzle 140 rotates in a clockwise direction. One side of tab 1202 may provide a surface that mechanism 1200 catches on and tightens when inlet nozzle 140 rotates in a clockwise direction, while another side of tab 1202 is a ramp or incline that will not engage mechanism 1200 when inlet nozzle 1200 rotates in a counter-clockwise direction. System 100 may allow for user input or automatic selection based on recognition and/or other identification of cartridge 112 to program the inlet nozzle 140 to rotate clockwise, which will allow tab 1202 to engage mechanism 1200 during brewing, or may allow for user input to program the inlet nozzle 140 to rotate counter-clockwise, which will avoid engagement of mechanism 1200 during brewing. Other types of engagement between inlet nozzle 140 and mechanism 1200 are possible without departing from the scope of the present disclosure.

If mechanism 1200 is engaged, a first set of conditions, such as pressure, temperature, volume, etc., for beverage material 114 will be created by mechanism 1200. If mechanism 1200 is not engaged, a second set of conditions for beverage material 114 is created, which may be similar to the set of conditions created by system 100 when mechanism 1200 is not present within cartridge 112.

Mechanism 1200, which is shown as a torsion spring, but may be any mechanism, may provide conditions for brewing that system 100 could not otherwise attain. For craft coffee beverages, e.g., “French press” coffee, “pour over” coffee, etc., system 100 may not be able to provide the pressure conditions within cartridge 112 without the use of mechanism 1200. If mechanism 1200 is not engaged, system 100 would produce a beverage similar to if not identical to the beverage produced if mechanism 1200 is not present. However, if mechanism 1200 is engaged during brewing, different pressures, localized temperatures, reduced volumes, etc., may produce a different beverage from the same cartridge 112.

Although mechanism 1200 is shown as a torsion spring, other mechanisms are possible within the scope of the present disclosure. Further, beverage material 114 may be located at specific locations within cartridge 112, such as along the side 208, along the bottom 212, etc., such that the combination of type of mechanism 1200 and placement of beverage material 114 within cartridge 112 provides operational advantages within system 100.

For example, and not by way of limitation, mechanism 1200 may provide additional pressure to beverage material 114 when mechanism 1200 is engaged by inlet nozzle 140. System 100 may be programmed to introduce fluid to cartridge 1200 for a certain amount of time and then stop introducing fluid. System 100 may then allow the fluid to drain from cartridge 112 for a certain amount of time, and then engage mechanism 1200 to pressurize the added fluid out of cartridge 112 through outlet needle 158. System 100 may then add more fluid to cartridge 112 and repeat these steps. Such an approach is similar to a “pour over” style of coffee brewing. Similar mechanisms 1200, beverage material 114 placement, and/or fluid delivery techniques may be combined to produce other types of brewing techniques in system 100. Such techniques are not currently employed in related systems 100.

### Variable Porosity and Flavor Additives

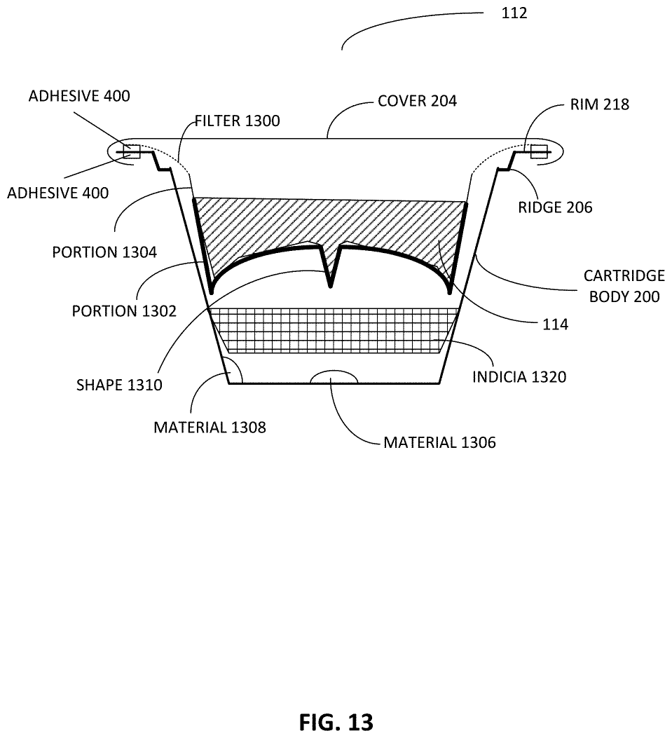

FIG. 13 illustrates a beverage cartridge in accordance with an aspect of the present disclosure. Cartridge 112 may comprise a filter 1300 which has a variable porosity. A portion 1302 of filter 1300 may have a first porosity value, while portion 1304 of filter 1300 may have a second porosity value. As such, fluid introduced into cartridge 112 may remain in portions of filter 1300 longer than in other portions of filter 1300.

For example, and not by way of limitation, portion 1302 may be less porous than portion 1304. As such, fluid 120 that is introduced into cartridge 112 will not flow through portion 1302 as fast, or at all, as fluid 120 that reaches the level of portion 1304. This may increase the time that fluid remains in contact with beverage material 114 that is contained within portion 1302. As the fluid level rises in cartridge 112, fluid 120 will flow out of portion 1304. This allows for more precise control of the time that fluid 120 remains in contact with beverage material 114. Through programming of system 100, e.g., fluid delivery flow rate, fluid delivery temperatures, etc., more precise brewing profiles may be achieved with system 100 through the use of variable flow rate filter 1300.

Further, to allow for increased pressure within cartridge 112 when employed in system 100, cover 204 may be wrapped around rim 218 and adhered to a larger surface of rim 218. The cartridge body 200 may be placed in a receptacle that allows for only small amounts of expansion of the cartridge body 200. In many cartridge 112 designs, the sealing surface of cover 204 to cartridge body 200 along rim 218 is the location of pressure blowouts experienced by cartridge 112. As such, increasing the pressure and force vectors that may be experienced at that location by encasing rim 218 with cover 204, and applying adhesive 400 to a larger surface of rim 218 (e.g., on both sides of rim 218), allows for greater pressure to be applied within cartridge 112 with fluid 120.

In an aspect of the present disclosure, cartridge body 200 may have a textured surface, specific color, other identifying marks, and/or indicia 1320 such that brewer 100 may recognize cartridge 112 as a specific type of cartridge 112. This recognition may be used to determine brewing characteristics, for rewards programs, and/or for any other reason. However, some users may try to use the same cartridge 112 several times to obtain additional rewards, or may accidentally attempt to reuse a cartridge 112. Because cartridge body 200 may be made from cellulose-based materials, and cartridge 112 may be placed under pressure when fluid 120 is delivered to cartridge 112, the pressure and/or water temperature may soften cartridge body 200. The pressure created by brewer 100 in delivering fluid 120 to cartridge 112 may allow for deformation of the surface of cartridge body 200. Further, the fluid 120, after passing through beverage material 114 and becoming beverage 128, may change the color of cartridge body 200. As such, the use of a given cartridge 112 in brewer 100 may alter and/or otherwise change the indicia 1320 such that the indicia 1320 no longer indicates the same information to brewer 100. Such changes in the indicia 1320 will allow brewer 100 to minimize reuse of the same cartridge 112, by alerting the user to reuse of a given cartridge 112, and/or minimize the recognition of cartridge 112 multiple times in rewards and/or accounting functions performed by brewer 100. Although indicated at a certain location on cartridge 112, indicia 1320 may appear anywhere on cartridge 112 without departing from the scope of the present disclosure.

Many cartridges 112 have added flavors and/or essences infused into beverage material 114. For example, some coffee beverages have hazelnut or caramel flavors infused or added to the beverage material 114. The process of infusing such flavors into beverage material 114 may add to the cost of cartridge 112, and/or the beverage material 114 may be degraded or otherwise altered by the infusion process. In an aspect of the present disclosure, materials 1306 and/or 1308 may be added to and/or infused into cartridge body 200, which may provide a more economical approach to inclusion of various additives in cartridge 112.

For example, and not by way of limitation, an essential oil may be added to cartridge body 200 at location 1506 and/or infused into a portion of or all of cartridge body 200. Since cartridge body 200 in an aspect of the present disclosure is cellulose-based, and is manufactured using oils and/or other binders, the infusion process may be less expensive than infusion of the same essential oil into beverage material 114. Further, infusion of the essential oil into cartridge body 200 may have fewer deleterious effects on beverage material 114 as well as fewer deleterious effects on the essential oil. A smaller amount of essential oil may be needed to provide the same flavors and/or other effects in the resultant beverage by placing the essential oil at location 1306 and/or 1308 than with beverage material 114.

Filter 1300 may also have a specialized shape 1310. Shape 1310 may accommodate inlet nozzle 140, or may be shaped to control one or more process parameters used during and/or after the brewing process. For example, and not by way of limitation, shape 1310 may be used to control the amount of time that fluid remains in contact with beverage material 114. Many shapes 1310 can be employed without departing from the scope of the present disclosure.

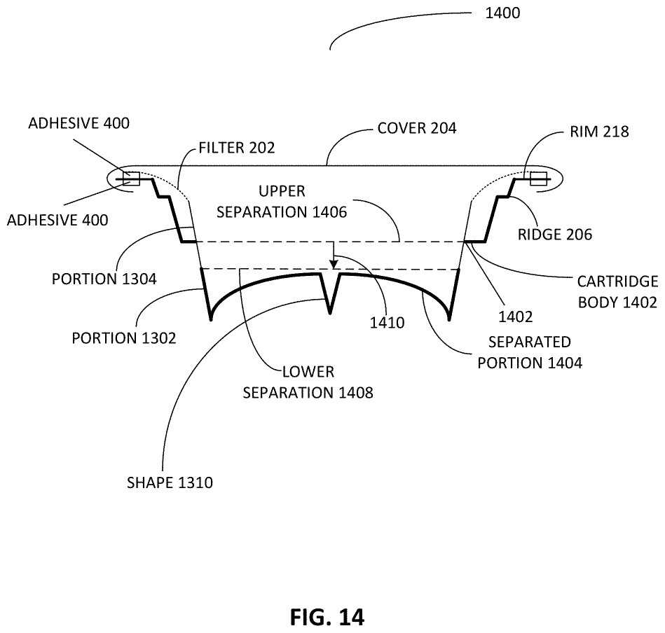

FIG. 14 illustrates a beverage cartridge in accordance with an aspect of the present disclosure. Some cartridges 112 do not have a body 200 that fully encloses the beverage material 114. Such cartridges 112 may be referred to as “soft pods.” One drawback of soft pods is that the beverage material 114 may be exposed to air or other oxidizing environments, which may deleteriously affect the beverage material 114.

In an aspect of the present disclosure, cartridge 1400 may be designed to have a separation line that exposes filter 1300. When placed in the system 100, cartridge 1400 has a cartridge body 1402 that separates from separated portion 1404 when fluid is introduced into cartridge 1400. The additional pressure introduced into cartridge 1400 by fluid 1400 may provide separation between cartridge body 1402 and separated portion 1404 such that the body 1402 and separated portion 1404 separate along upper separation line 1406 and lower separation line 1408. Separated portion 1404 moves away from body 1402 in direction 1408.

The upper and lower separation lines 1406/1408 may be a perforation line on cartridge 1400. Since the pressure in system 100 may be controlled, the pressure system 100 produces can be controlled to separate cartridge 1400 into body 1402 and separated portion 1404. Filter 202 may couple body 1402 and separated portion 1404, or separated portion 1404 may not completely separate from body 1402. So long as pressure is released by the separation of body 1402 and separated portion 1404, fluid entering cartridge 1400 will flow through filter 202 once separated portion 1404 has separated from body 1402. In such an aspect of the present disclosure, cartridge 1400 may provide better protection of beverage material 114 than a soft pod, and may further reduce the cost of production of cartridge 1400.

The present disclosure provides several advantages over the related art approaches. The present disclosure allows for easy separation of compostable and recyclable materials, and may allow for a cartridge that may be home-compostable (as opposed to compostable at a commercial facility). The present disclosure also allows for safer operation of beverage systems 100 that employ cartridges 112, in that possible unwanted by-products produced by cartridge 112 during the operation of beverage system 100 are not produced and/or consumed.

Further, the present disclosure allows for different types of filtration of beverage material 114, which may be desirable depending on the volume of beverage 128 to be produced from beverage material 114 in cartridge 112. The present disclosure also allows for additional types of beverages 128 to be produced, as well as allowing for richer, more flavorful beverages to be produced by currently deployed beverage systems 100. The present disclosure also provides upgrades to single-serve beverage systems 100 which may enable these systems to employ brewing methods, such as craft brewing methods, that present systems 100 cannot accommodate.

### Beverage Brewing System

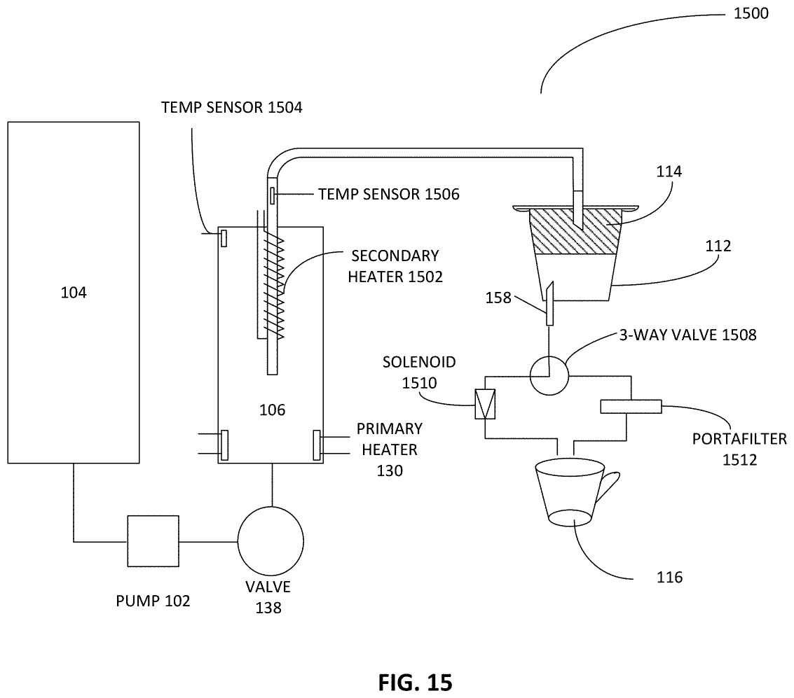

FIG. 15 illustrates a beverage brewing system in accordance with an aspect of the present disclosure.

Because cartridges 112 in accordance with one or more aspects of the present disclosure may provide additional operating conditions for brewer 100, a system 1500 designed to take advantage of these potentially available increased operating ranges, and/or additional capabilities of cartridges 112 in accordance with one or more aspects of the present disclosure, is disclosed herein in an aspect of the present disclosure.

### Volume, Temperature, Pressure, Time

Making a beverage, e.g., coffee, tea, etc., entails the control of several factors. For example, and not by way of limitation, the taste of a coffee drink can be altered by changing the amount of ground coffee used, the fineness/coarseness of the coffee grounds, and the amount of water used for a given amount of coffee grounds, among other factors. In an aspect of the present disclosure, selective control of one or more of these factors may be performed by system 1500. Further, system 1500 may be able to selectively control one or more of these factors for a given cartridge 112 such that a variety of flavors and/or beverages may be made from that given cartridge 112.

The factors that can be controlled include, but are not limited to, the volume of fluid delivered, the ratio of fluid to beverage material 114, the temperature of the fluid, the temperature differential between the fluid and the beverage material 114, the amount of beverage material 114 present in cartridge 112, the pressure at which the fluid is delivered to beverage material 114, the volume of the beverage material 114, i.e., how compacted or compressed the beverage material 114 is, the style of beverage material 114, e.g., blonde roast, dark roast, etc., and the amount of time that the fluid is delivered to the beverage material 114. With so many variables to control, some of the variables may be controlled by system 1500; however, in an aspect of the present disclosure, a user may override the system-controlled variables as desired.

When a user selects a given cartridge 112, e.g., a dark roast coffee cartridge 112, the amount of beverage material 114 may not be a variable that the user can control. However, in an aspect of the present disclosure, the user may control the time, temperature, pressure, and/or compaction of the beverage material to produce different flavor profiles and/or different beverages from the selected cartridge 112.

For example, and not by way of limitation, a dark roast coffee cartridge 112 may be placed into system 1500. A user may select inputs on system 1500 to produce one or more drip-brewed style beverages, or the user may select inputs on system 1500 to produce one or more espresso-style beverages. The inputs may be as simple as pressing a “drip coffee” or “espresso” button, or may allow for individual control of one or more of the variables to produce a more customized beverage.

A related equation to the control of the flavors produced from a given cartridge 112 is the ideal gas law. The ideal gas law is: PV=nRT, where P is the pressure, V is the volume, n is the number of moles of material (e.g., amount of fluid, amount of gas, etc.) present, R is a constant, and T is the temperature. The ideal gas law is a good approximation of the behavior of most gases and fluids under various conditions. What may be important about the ideal gas law with respect to system 1500 is that the volume of a given sample increases linearly with temperature for a constant pressure, the pressure of a given sample increases linearly with temperature for a given volume, and that pressure and volume are proportional to temperature. These effects can be seen in a pressure cooker, where water that usually boils at 212 degrees Fahrenheit now can produce temperatures of 230 degrees Fahrenheit or higher, because the volume and amount of fluid is a fixed amount, and as the pressure rises, so must the temperature to maintain the PV=nRT relationships.

### Volume (Fluid to Beverage Material Ratio)

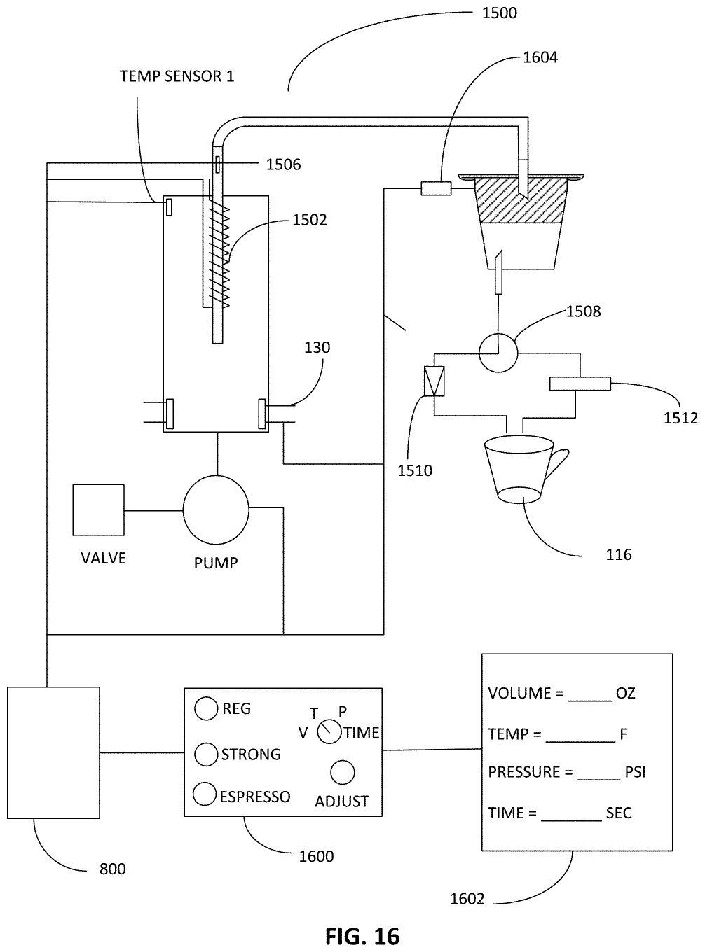

System 1500 may comprise one or more controls to vary the amount of fluid being delivered to cartridge 112. For example, and not by way of limitation, a set of buttons or knob as shown in FIG. 16 may be provided to allow a user to vary the amount of fluid that the user desires to be present in the final beverage. Many users may select a common amount, e.g. 8 fluid ounces (fl. oz.), 10 fl. oz., 12 fl. oz., etc. In an aspect of the present disclosure, system 1500 may alter the selected amount by adding a small increment to the user selected amount to account for fluid that may be retained within cartridge 112 after the fluid has been delivered. For example, and not by way of limitation, if a user selects an 8 fl. oz. beverage, system 1500 may deliver 8.2 fl. oz of fluid to cartridge 112, because cartridge 112 may retain 0.2 fl. oz. of fluid in beverage material 114, cartridge body 200, filter 202, etc. Different cartridges 112 may retain a different amount of fluid, and, in an aspect of the present disclosure, system 1500 may deliver different amounts of fluid for the same user selection based on indicia 1320 (shown in FIG. 13), or other inputs to system 1500, without departing from the scope of the present disclosure.

In an aspect of the present disclosure, system 1500 may allow a user to select the amount of fluid that delivered to cartridge 112 rather than selecting the amount of fluid that will eventually be delivered to container (e.g., mug, cup, carafe, etc.) 116. As the amount of beverage material 114 in a sealed cartridge 112 is fixed at the time of manufacture, in an aspect of the present disclosure, a user may be able to select the ratio of fluid to beverage material 114 to create a custom “brew” or beverage. In an aspect of the present disclosure, rather than selecting a final beverage size, a user may wish to create a specialty drink that system 100 prepares based on a fluid:beverage material 114 ratio.

### Pressure (Pressure Differential)

In an aspect of the present disclosure, beverage material 114 may be subjected to different pressures of delivered fluid to produce different flavor profiles. For example, and not by way of limitation, a dark roast coffee beverage material 114 may be subjected to a small pressure of fluid that is allowed to “drip” through the beverage material 114 to create a drip-style coffee beverage. For the same dark roast coffee beverage material 114, additional pressure of fluid may produce a more espresso-like coffee beverage by changing the pressure at which fluid is delivered.

In an aspect of the present disclosure, pump 102 in system 1500 may be operated at a first pumping condition, which delivers fluid at a first pressure to cartridge 112. Pump 102 may also be operated at a second pumping condition, that delivers fluid at a second pressure to cartridge 112. In another aspect of the present disclosure, one or more valves 1506/1508 may be closed to create a back pressure within cartridge 112, or to create a greater pressure differential over a smaller area, to allow for fluid to be pressurized when delivered to beverage cartridge 112.

For example, and not by way of disclosure, in an espresso machine, water is delivered at high pressure (12-20 bar) to a compacted volume of coffee grounds. The water is restricted from exiting the high pressure system by a number of small holes in a filter, known as a portafilter 1512, that is placed opposite to where the water entered the volume, and exits the pressurized portion of the machine to atmospheric pressure. This difference in pressure at the interface where the water is in contact with the coffee grounds and where the water exits the espresso machine (where there is a difference in pressure) is where entrained gasses are released from the interaction of the water and the coffee grounds. Again, because the pressure changed, while temperature remained the same, the volume of the gas (and the fluid) must expand to maintain the equality of PV=nRT.

### Temperature

As with other controllable variables described herein, system 1500 may control the temperature of the fluid delivered to beverage material 114, and/or the temperature differential between the fluid delivered to beverage material 114 and the beverage material 114 itself In an aspect of the present disclosure, system 1500 may deliver fluid at a first temperature when a first set of brewing conditions are selected, and may deliver fluid at a second temperature when a second set of brewing conditions are selected.

In an aspect of the present disclosure, the temperature of the fluid being delivered may be monitored during delivery of the fluid, in order to control the temperature profile of the fluid as it is being delivered to the beverage material. For example, and not by way of limitation, the fluid may be delivered to beverage material at a first temperature when the brew cycle is started, and that first temperature may be maintained throughout the brew cycle by selectively activating one or more heating elements in the heater. However, for other flavor profiles, other types of beverages, etc., the temperature of the fluid may be changed during the brew cycle to alter the amount and/or type of flavors extracted from a given beverage material 114. Other temperature profiles may also be possible without departing from the scope of the present disclosure.

### Time of Contact Between Fluid and Beverage Material

The amount of time that the fluid remains in contact with the beverage material 114 may also be controlled within system 1500. By leaving fluid in contact with beverage material 114 longer, additional and/or different flavors may be extracted from a given beverage material 114. The amount of time that the fluid remains in contact with beverage material 114 may be controlled by one or more valves preventing the fluid from leaving cartridge 112, delivering the fluid at a slower rate to cartridge 112, delivering the fluid at intervals, e.g., batch fluid delivery to beverage material 114, and/or other methods, without departing from the scope of the present disclosure.

### Types of Coffee Beverages

Popular coffee beverages include brewed coffee and espresso. However, within each of the general headings of “brewed coffee” and “espresso” are variations that may more precisely describe what a particular user is trying to achieve in terms of a flavor profile, and, as such, are possible in one or more aspects of the present disclosure.

Coffee drinks are made by combining hot or cold water with ground coffee beans in a process called “brewing.” Brewing is done: 1) at approximately atmospheric pressure with an apparatus that filters and/or separates the grounds from the water at some point in the process such that the beverage can be decanted, or 2) using pressurized water forced through coffee grounds.

### Brewed Coffee Beverages

The “brewed coffee” (i.e., made at approximately atmospheric pressures) approach may be done by a variety of apparatuses, e.g., French Press, percolator, drip machine, pour over carafe, etc. Drip-brewed coffee (sometimes referred to as “filtered” coffee) is brewed by passing hot water over roasted, ground coffee beans that may be contained in a filter. Water seeps through the ground coffee, absorbing its oils, flavors and essences, usually using gravity to pull the water through the coffee grounds, then passes through the filter. The used coffee grounds are retained in the filter with the liquid falling (dripping) into a collecting vessel.

Coffee may also be made using a device called a “French Press”, which is also known as a press pot, coffee press, coffee plunger, cafetière or cafetière à piston. French press coffee may use coffee beans that are more coarsely ground than drip or filtered coffee, as finer grounds will seep through the press filter and into the coffee beverage. French press coffee may be brewed by placing ground coffee in a container and adding hot (93-96 degrees Celsius, 200-205 degrees Fahrenheit) water, in proportions of about 28 grams (1 ounce) of coffee to 450 ml (15 fluid ounces) of water, more or less to taste. After a desired amount of time, a plunger is pressed to hold the coffee grounds at the bottom of the container, while the coffee beverage is decanted from the container. Depending on how long the water remains in contact with the coffee grounds, as well as the temperature of the water, different flavor profiles may be obtained from a given type of coffee bean.

Cold brewing, also called cold water extraction, cold pressing, Kyoto-style coffee, and/or Dutch coffee, is the process of steeping coffee grounds in water at cool temperatures and/or dripping cool water over coffee grounds for an extended period. Coarse-ground beans are soaked in water for a prolonged period of time, e.g., for 12 to 24 hours. The water may be kept at room temperature, but chilled water may also be used. The grounds are filtered out of the water after they have been steeped using a filter, e.g., a sieve, paper, felt, etc. The result is a coffee concentrate that may be served hot, over ice, or blended. Cold brew coffee can be infused with nitrogen to make nitro cold brew coffee. Brewing coffee at a lower temperature results in lower acidity and lower caffeine content when brewed in equal volume. Although less caffeine may be extracted using a cold brew method, a higher coffee-to-water ratio may be used, e.g., between 2 and 2½ times that used in hot water brewing methods.

Percolated coffee is made by cycling boiling or nearly-boiling water through the grounds using gravity. Even after the initial pass through the coffee grounds, the fluid that has already absorbed some coffee flavors, oils, etc., is passed through the coffee grounds multiple times to continue extracting additional oils from the coffee grounds.

Turkish coffee is made by grinding coffee beans to a fine powder consistency and immersing the powdered coffee in water. The powdered coffee/water combination is then heated until the liquid reaches the boiling point. The Turkish method may produce additional “foam” or “crema” as the gases entrained in the coffee beverage are given additional temperature (approximately 212 degrees Fahrenheit) to allow a larger amount of the gases to expand and escape from the coffee beverage liquid. If the coffee is left to boil for a longer period of time less crema may remain, as the oils and gases may also be released from the liquid into the surrounding atmosphere.

### Pressure-Brewed (Espresso) Coffee Beverages

Although pressure-brewed coffee is often referred to as “espresso”, there are many species of coffee beverages that fall under the espresso “genus.” Again, by varying the time of contact, temperature, pressure, and volume of fluid used, different flavor profiles may be obtained from a given beverage material 114.

### Types of Espresso

Espresso is brewed by forcing a small amount of nearly boiling water, sometimes accompanied, preceded, and or followed by steam. The water is heated to about 86 to 95° C. (187 to 203° F.) and delivered to the coffee grounds under pressure of about 9 to 20 bar (130-290 psi). Espresso is generally denser than coffee beverages brewed by other methods, having a higher concentration of suspended and dissolved solids, and generally has a creamy foam on top termed “crema.” Cartridges of the present disclosure can withstand such pressures, and can withstand pressures of at least 2 Bar, whereas cartridges in the related art can only withstand pressures of 1.17-1.18 Bar.

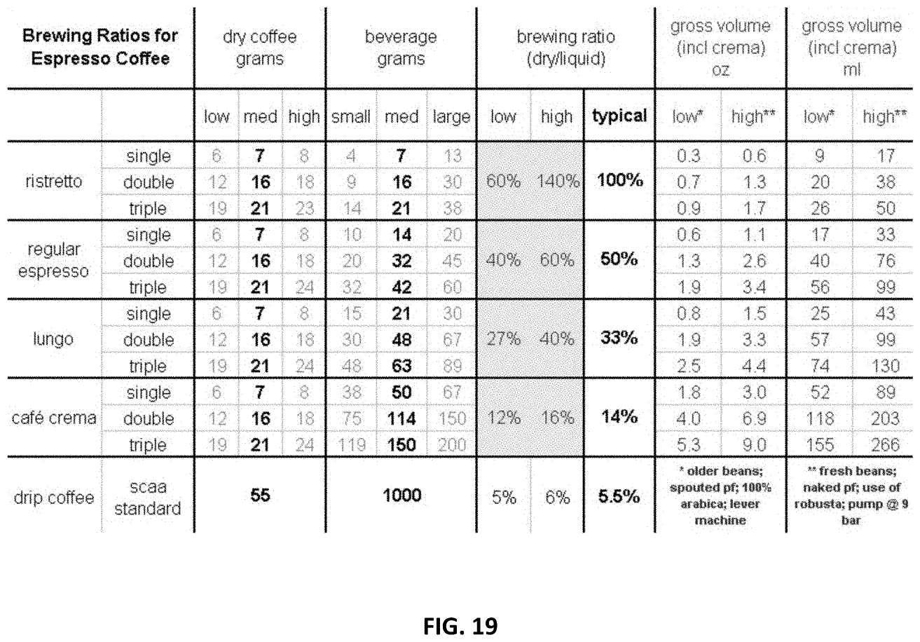

Although there is no actual “standard” brew of espresso, coffee makers generally agree that an “espresso” (also known as a “normale” espresso) is a coffee drink that uses approximately a 50% ratio of beverage material 114 to fluid (i.e., 1 part beverage material 114 to 2 parts fluid, or 2:1). A “single” espresso may be referred to as a “shot” of espresso, which is prepared using approximately 7 grams (0.246 ounces) of ground coffee beans as beverage material 114 to create a 14 gram (0.49 ounces) beverage. The volume of the final beverage, because of the pressures and temperatures involved, includes the crema volume, which results in an approximately 1 fl. oz. beverage overall. “Double espresso” would use twice the amount of beverage material 114 and twice the amount of fluid to create a final beverage having approximately twice the overall volume. A table of “regular” espresso drinks is shown in FIG. 19. Using that definition as the baseline, variations on the “espresso” drink have been created and named. Although some alternative names have been included herein, other names may be used in various parts of the world to describe similar beverages. Additional ingredients, e.g., lemon twists, lime wedges, milk, cream, flavors, etc., may be included with the descriptions provided herein without departing from the scope of the present disclosure.

### Ristretto (Café Serré)

Ristretto, also known as Café Serré, is Italian for “shortened” or “narrowed”. Ristretto may be made by using approximately a 100% ratio of beverage material 114 to fluid (i.e., equal parts beverage material 114 and fluid, or 1:1). A ristretto is prepared in the same amount of time as an espresso, but because it uses half of the amount of fluid as an espresso, produces a different, often more concentrated, flavor profile per volume of beverage made. The difference in the ratio between water and fluid over the same amount of time means that in an espresso, the water must be provided at a higher pressure to force a larger volume through the coffee grounds in the same amount of time, and a ristretto uses less pressure in extracting the flavor profile.

### Lungo (Allongé)

Lungo, also known as an “allongé” is Italian for “long”. A cafe lungo may be made by using approximately a 33% ratio of beverage material 114 to fluid (i.e., 1 part beverage material 114 to 3 parts fluid, or 3:1). A lungo may take longer to prepare, and as such, similar fluid pressure to that of the espresso beverage may be used. Because of the longer time that the fluid remains in contact with the beverage material 114, a different flavor profile may be produced.

A lungo is often less strong but more bitter than an espresso, because the additional hot water passing through the coffee grounds may extract flavor components that would normally remain in the coffee grounds. As more water is passed through the coffee grounds, there are fewer and/or different types of flavors extracted, which may change the taste. Further, since there is more fluid and the same or similar amounts of extracted constituents, the lungo may be more “watery” or “thinner” than an espresso.

As the amount of fluid is increased or decreased relative to the amount of coffee grounds, the flavor composition of the resultant beverage may change because the flavor components of coffee dissolve at varying rates. As such, a lungo or ristretto may not contain the same ratio and/or concentrations of flavor components as an espresso. Although these differences may sometimes be described as having a “stronger” or “weaker” taste, the differences between the lungo, ristretto, and espresso also include different flavors and/or components in each of the different drinks.

### Americano and Long Black

Caffè Americano, or simply Americano (the name is also spelled with varying capitalization and use of diacritics: e.g. Café Americano, Cafe Americano, etc.) is a style of coffee prepared by adding hot water to espresso, giving a similar strength to but different flavor from brewed (at atmospheric pressure) coffee. Americano may be a single espresso and/or double espresso combined with between 1 and 16 fluid ounces (30-470 ml) of hot water. The strength of an Americano varies with the amount of espresso used and the amount of water added.

A long black is an espresso added to hot water, which may end up slightly different in flavor than an Americano, as the crema of the espresso may be preserved by changing the base and additive components of the drink.

### Café Cubano

Café Cubano, also known as Cuban coffee, Cuban espresso, cafecito, a Cuban pull, or a Cuban shot, is a strong, sweet beverage where sugar is mixed with the coffee grounds before brewing. Café Cubano can be made using espresso in one or more forms, as well as with a brewed (filtered) coffee preparation method. Various forms of sugar, e.g., demerara sugar, white, brown, etc., may be used in the preparation, and the sugar may not be brewed with the coffee grounds, but may be placed (instead of or in conjunction with) in the coffee cup as the coffee beverage drips into the cup. The final beverage may be stirred or whipped into a froth. Café Cubano may have variations including a small portion of milk or cream, known as a cortadito, or with steamed milk, which may be known as café con leche.

Caffè crema

Caffè crema, which is Italian for “cream coffee,” is also known as “café traditionnel” or “café crema” in some parts of the world. Caffè crema may be made by using approximately a 12-14% ratio of beverage material 114 to fluid (i.e., 1 part beverage material 114 to 7 parts fluid, or 7:1). A caffè crema may take longer to prepare, or may use a different grind of the coffee beans, which would produce different amounts of pressure and/or contact time between the fluid and the coffee beans. Because of the difference(s) in preparation variables, a different flavor profile will be produced. An example of a caffè crema preparation is using 67-200 (or more) millilitres (6.3-8.4 imp fl oz; 6.1-8.1 US fl oz) of water with between 7 and 21 grams of coffee grounds and using approximately the same pressure and temperature as when brewing an espresso. The taste profile of a caffè crema may be similar to an Americano or a long black, but is extracted differently and thus may have a slightly different flavor profile.

As a larger volume (“longer”) beverage than ristretto and lungo, and because caffè crema is brewed rather than diluted as Americano/long black beverages, caffè crema is the long end of the ristretto-normale-lungo-caffè crema range. Caffè crema may be significantly longer than a lungo, and is generally twice as long (twoce the volume of fluid).

Rough brewing ratios of ristretto, normale, lungo, and caffè crema are 1:2:3:6—a doppio (double) ristretto will be approximately 1 oz/30 ml (crema increases the volume), normale 2 oz/60 ml, lungo 3 oz/90 ml, and caffè crema 6 oz/180 ml. However, volumes of caffè crema can vary significantly, from 4-8 oz (120 m1-240 ml) for a double shot, depending on how it is brewed and the user's taste. In terms of solubles (total dissolved solids in the final beverage) concentration, a caffè crema is approximately midway between a lungo and non-pressure brewed coffee, such as drip or press. The motivation to make a caffè crema versus an espresso or lungo is that caffè crema is a larger serving of beverage, and similar in serving size to brewed (filtered) coffee, but still retains the extraction flavor profiles of espresso-style beverages.

### Moka

Moka coffee is a beverage brewed with a stovetop coffee maker (“moka pot”) which produces a beverage by passing hot water pressurized by steam through ground coffee. The pressure may be at a lower pressure than espresso pressure levels (approximately 12 bar). The flavor profiles of moka pot-style coffee may depend on the levels of heat and pressure used. Due to the higher-than-atmospheric pressure involved, the mixture of water and steam reaches temperatures well above 100° C., causing a different extraction of flavors and/or other solutes from the coffee grounds, and may result in a stronger flavor profile than that obtained by atmospheric pressure brewing.

### System Operation

In order to prepare one or more of the various styles of drinks, e.g., brewed coffee, espresso types, etc., the descriptions herein indicate that, as previously discussed in the present disclosure, system 1500 may control time, temperature, pressure, and volume of fluid delivered to beverage cartridge 112 to vary the types of drinks made from a given beverage cartridge 112.

As shown in FIG. 15, system 1500 is similar to that shown in FIG. 1, in that there is a reservoir 104, pump 102, valve 138, heater 106, etc.

In system 1500, upon starting the system 1500, fluid is pumped into heater 106 to heat a certain amount of fluid to a first temperature. The first temperature may be 190° F., or may be other temperature settings, without departing from the scope of the present disclosure. To heat the fluid, primary heater 130 and/or secondary heater 1502 may be used to heat the fluid. To determine and/or regulate the temperature of the fluid in heater 106, temperature sensor 1504 may be used as a feedback mechanism.

When a brewing cycle is initiated, the user may input one or more parameters to system 1500. The user may select “brewed” as a button selection or “strong” as a button selection, in which cases system 1500 may have preset volumes, temperatures, pressures, and/or times of fluid delivery to a beverage cartridge 112. The user may also be able to select one or more of these parameters to adjust the volume, temperature, pressure, and/or time for the user's preferred drink from a given beverage cartridge 112.

System 1500 may include additional elements such as temperature sensor 1506, which may measure the temperature of the fluid leaving heater 106, valves 1508 and/or 1510 which may control the flow of fluid and/or gas after leaving cartridge 112 and/or the pressure across beverage material 114, and/or portafilter 1512 which may control the flow and/or pressure of the fluid across the beverage cartridge 112 and/or beverage material 114.

FIG. 16 illustrates a system in accordance with an aspect of the present disclosure.

Within system 1500, in order to enable the various selections of time, temperature, pressure, and/or volume, additional controls 1600 may be present for user-selection of one or more factors used to brew beverages, which variations may be shown on display 1602. Although a specific configuration of controls is shown in FIG. 16, any combination or permutation of controls may be used without departing from the scope of the present disclosure.

Further, system 1500 may also include a sensor 1604 that detects a difference between a cartridge 112 that can withstand higher temperatures and/or pressures, e.g., a cartridge 112 made from pulp, natural fibers, etc., and a cartridge 112 made from plastic. Sensor 1604 may be, for example, a plunger switch, an optical sensor, etc., that provides a signal to processor 800 to prevent a user from attempting to use a plastic cartridge 112 in conditions that the plastic cartridge 112 cannot withstand. For example, and not by way of limitation, sensor 1604 may be a plunger switch that is in one state (open or closed) when a plastic cartridge 112 is placed in system 1500, and in another state (closed or open) when a non-plastic cartridge is placed in system 1500. Sensor 1604 may allow for backward compatibility of system 1500 with cartridges that are not designed to withstand certain operational conditions, temperatures, and/or pressures, while still allowing system 1500 to provide those capabilities when the proper cartridge 112 is inserted into system 1500.

To differentiate between one type of cartridge 112 and another, the indicia described with respect to FIG. 13 may be used, or cartridges 112 that can withstand higher pressures, temperatures, and/or other operational conditions may have a slightly different shape than other cartridges 112. For example, and not by way of limitation, a certain portion of the cartridge body 200 may have a different circumference, e.g., the top portion of cartridge body 200, when the cartridge body 200 is made of pulp, natural fibers, etc., and can withstand higher operational characteristics than a plastic cartridge body 200. In such an example, a plunger switch can detect the difference between the two types of cartridges 112 (by the difference in cartridge body 200 diameters) and send a signal to processor 800 to allow/disallow certain operational conditions for each type of cartridge 112.

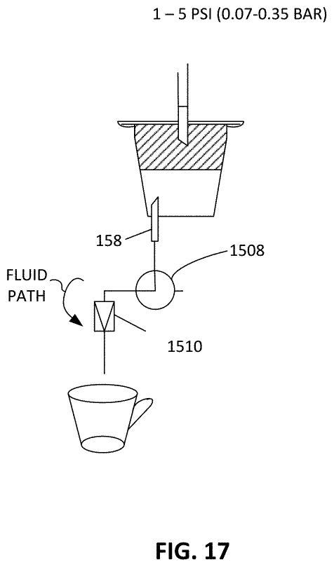

As shown in FIGS. 15 and 16, valve 1508 may be operated to allow for fluid to flow in various conduits after brewing. If valve 1508 is in one position, as shown in FIG. 17, the outflow of fluid through outlet needle 158 may be directed toward valve 1510, which may be a solenoid valve, a check valve, or other type of valve that can be controlled as to when fluid flows through valve 1510. As such, as fluid flows through outlet needle 158, valve 1510 can provide backpressure that resists the flow of fluid out of outlet needle 158. By selective opening and closing of valve 1510, additional pressure may be applied to the fluid after brewing the beverage in cartridge 112, and, as such, the pressure upon the resultant beverage may be increased and/or decreased. As described herein, this change in pressure may allow for different types of beverages to be produced.

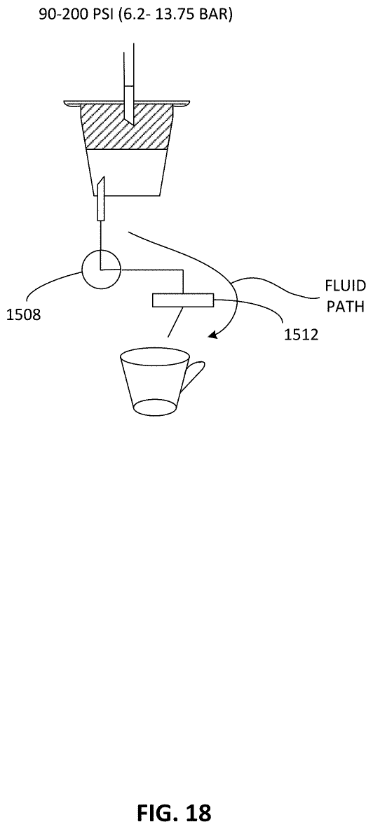

If valve 1508 is in another position, as shown in FIG. 18, the fluid may flow through a portafilter 1512. Portafilter 1512 may be a metal plate with known-sized holes to enable additional known pressure to be applied to the fluid after leaving outlet needle 158. This additional pressure and/or change in pressure provided by portafilter 1512 may also allow for different types of beverages to be produced for a given cartridge 112.

The position of valve 1508, and the state (open/closed/partially open) of valve 1510 may be controlled by microcontroller 800. Further, the hole size in portafilter 1512 may also be controlled by microcontroller 800 if desired. Microcontroller 800 may also control the pressure, fluid temperature, etc., as described herein.

As shown in FIG. 16, such control may be via a control panel 1600 having various knobs, buttons, etc. to control the volume, temperature, pressure, and/or time of contact, and a display 1602 that may display the volume of the final beverage, temperature of the fluid, pressure being applied, and/or the time of fluid contact. Other types of control panels 1600 and/or displays 1602 are possible within the scope of the present disclosure.

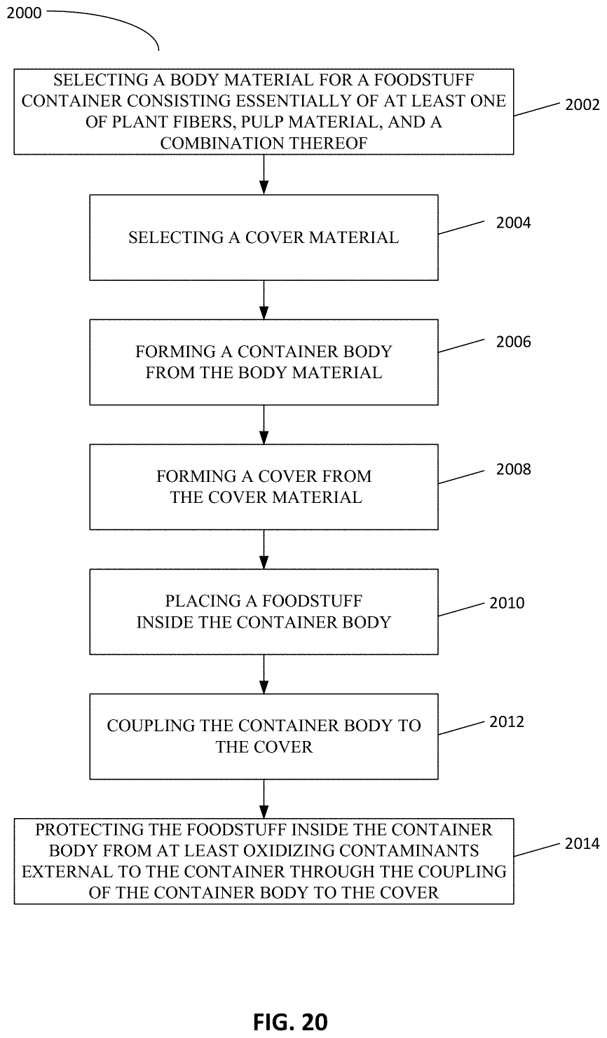

FIG. 20 illustrates a process flow in accordance with an aspect of the present disclosure.

Process flow 2000 begins with block 2002, which represents selecting a body material for a foodstuff container, the body material consisting essentially of at least one of plant fibers, pulp material, and a combination thereof. Block 2004 represents selecting a cover material. Block 2006 represents forming a container body from the body material. Block 2008 represents forming a cover from the cover material. Block 2010 represents placing a foodstuff inside the container body. Block 2012 represents coupling the container body to the cover, and block 2014 represents protecting the foodstuff inside the container body from at least oxidizing contaminants external to the container through the coupling of the container body to the cover.

If implemented in firmware and/or software, and/or as part of microcontroller 800 and/or memory 802/804, the functions described herein may be stored as one or more instructions or code on a computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include RAM, ROM, EEPROM, CD-ROM or other optical disk storage, magnetic disk storage or other magnetic storage devices, or other medium that can be used to store desired program code in the form of instructions or data structures and that can be accessed by a computer (e.g., microcontroller 800); disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors (e.g., microcontroller 800) to implement the functions outlined in the claims.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can include RAM, ROM, EEPROM, CD-ROM or other optical disk storage, magnetic disk storage or other magnetic storage devices, or any other medium that can be used to carry or store specified program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The present disclosure is described herein with reference to certain embodiments, but it is understood that the disclosure can be embodied in many different forms and should not be construed as limited to the embodiments set forth herein. In particular, the present disclosure is described below in regards to certain modules having features in different configurations, but it is understood that the present disclosure can be used for many other modules and/or configurations. The modules and systems can also have many different shapes beyond those described below.

All physical dimensions, weights, temperatures, etc. in the description and attached drawings are exemplary in nature. It is understood that embodiments of the present disclosure can have various dimensions/weights/temperatures/etc. varying from those shown in the attached drawings.

Although the present disclosure and its advantages have been described in detail, it should be understood that various changes, substitutions and alterations can be made herein without departing from the technology of the disclosure as defined by the appended claims. It should also be understood that when a feature or element may be referred to as being “on” another element, it can be directly on the other element or intervening elements may also be present unless specifically stated otherwise. Furthermore, relative terms such as “inner”, “outer”, “upper”, “above”, “lower”, “beneath”, and “below”, and similar terms, may be used herein to describe a relationship of one element or attribute to another. With regard to the figures, it is to be understood that these terms are intended to encompass different orientations of the device in addition to the orientation depicted.

Moreover, the scope of the present application is not intended to be limited to the particular configurations of the process, machine, manufacture, composition of matter, means, methods, and/or steps described in the specification. As one of ordinary skill in the art will readily appreciate from the disclosure, processes, machines, manufacture, compositions of matter, means, methods, and/or steps, presently existing or later to be developed, that perform substantially the same function or achieve substantially the same result as the corresponding configurations described herein may be utilized according to the present disclosure. Accordingly, the appended claims are intended to include within their scope such processes, machines, manufacture, compositions of matter, means, methods, and/or steps.

Although the terms first, second, etc. may be used herein to describe various elements, components, regions, and/or sections, these elements, components, regions, and/or sections should not be limited by these terms. These terms are only used to distinguish one element, component, region, or section from another element, component, region, or section. Thus, a first module, element, component, region, or section discussed below could be termed a second module, element, component, region, or section without departing from the teachings of the present disclosure.

The description of the disclosure is provided to enable any person reasonably skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

1. A method of manufacturing a compostable foodstuff container, comprising:
selecting a body material for a foodstuff container, the body material consisting essentially of at least one of plant fibers, pulp material, and a combination thereof, and a body binding material consisting of a sugar;
selecting a cover material, the cover material consisting essentially of at least one of plant fibers, pulp material, and a combination thereof, and a cover binding material, the cover binding material consisting of a sugar;
forming a container body from the body material,
forming a cover from the cover material,
placing a foodstuff inside the container body;
coupling the container body to the cover; and
protecting the foodstuff inside the container body from at least oxidizing contaminants external to the container through the coupling of the container body to the cover.

2. The method of claim 1, the cover material consisting essentially of at least one of plant fibers, pulp material, and a combination thereof.

3. The method of claim 1, in which the foodstuff is a beverage material.

4. The method of claim 3, in which the beverage material is coffee grounds.

5. The method of claim 1, in which the foodstuff container is a beverage cartridge.

6. The method of claim 1, in which the foodstuff container is capable of withstanding an internal pressure of greater than 2 Bar.

7. The method of claim 1, in which the foodstuff container begins a process of decomposition when the foodstuff container is exposed to liquids during a brewing operation.

8-14. (canceled)

15. The method of claim 6, in which the container body has a frustoconical shape.
